(19) United States
(12) Patent Application Publication
(10) Pub. No.: US 2025/0163540 A1
(43) Pub. Date: May 22, 2025

(54) METHODS OF CHEMICAL SEPARATION USING SELECTIVE AND SEQUENTIAL PRECIPITATION IN REACTION-DIFFUSION GEL MEDIA

(71) Applicant: BATTELLE MEMORIAL INSTITUTE, Richland, WA (US)

(72) Inventors: ELIAS NAKOUZI, Richland, WA (US); QINGPU WANG, Shoreline, WA (US)

(73) Assignee: BATTELLE MEMORIAL INSTITUTE, Richland, WA (US)

(21) Appl. No.: 18/921,845

(22) Filed: Oct. 21, 2024

Related U.S. Application Data
(60) Provisional application No. 63/544,836, filed on Oct. 19, 2023.

(51) Int. Cl. C22B 3/24

(52) U.S. Cl. CPC C22B 3/24

(57) ABSTRACT

A reaction-diffusion method for material separation using inexpensive and scalable gel medium (such as agarose or gelatin in a cylindrical tube) and a precipitating agent (such as sodium hydroxide, potassium hydroxide, or an oxalate). Basic embodiments place a solution containing dissolved ions containing one or more metals of interest in contact with a hydrogel that contains at least one precipitation agent. Diffusion and precipitation reactions occur over time to cause physical displacement or separation and thus cause enhanced concentration of different ions at different locations or depths within the hydrogel.

### RELATED APPLICATIONS

This application claims benefit of U.S. Patent Application No. 63/544,836 filed Oct. 19, 2023. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

Embodiments relate to methods for physically separating solutions of ionic materials that include target metals (e.g., in the form of ions, atoms, molecules, or metal clusters) and, in some embodiments, using such methods as part of a target metal recovery process.

### Background Information

The challenging reality is that transitioning to a green economy will be powered by critical materials, whose sourcing is fraught with environmental, ethical, and supply chain concerns. These critical materials, as identified by the US Department of Energy (DOE), include rare earth elements (REEs) that are important for a variety of technologies.

Traditionally, REEs are mined from mineral ores through complex energy- and chemical-intensive processes. Upon extraction, the ores are concentrated through physical beneficiation involving flotation-, magnetic-, and gravity-based methods. Subsequently, they undergo roasting to decompose the carbonate minerals, acid leaching to dissolve the various minerals, re-precipitation with alkaline solutions to extract impurities such as iron, and solvent extraction to recover the target REEs. While this separation process is widely deployed at the industrial scale, it has multiple disadvantages including large chemical requirements, generation of hazardous byproducts, the use of toxic organic extractants, and low efficiency for separating dilute feedstocks.

Accordingly, there is increasing interest in sourcing REEs from unconventional feedstocks that are more environmentally sustainable and address mounting supply chain challenges.

Unconventional feedstocks include, for example, industrial runoff, produced water, and legacy wastes at abandoned mining sites (of which more than 50,000 exist in the United States alone). Such feedstocks contain valuable metal components; however, such feedstocks consist of highly variable and complex mixtures, which render the extraction of target materials economically and environmentally challenging.

Another feedstock includes electronic waste, of which the world produces more than 50 million tons annually, valued at more than $60 billion. Only 20% of these waste materials are currently recycled. Neodymium-iron-boron (NdFeB) permanent magnets represent a substantial quantity of electronic waste due to their rapidly increasing use in electric motors. NdFeB magnets are composed of 25-35% REEs (mainly Nd, Pr, and Dy), 60-70% iron (Fe), and ˜1% boron (B). These critical elements may be recovered from spent or scrap magnets using hydrometallurgical, pyrometallurgical, or electrometallurgical processing methods in the form of mischmetals, salts, and oxides. However, many of these processes are performed at elevated temperatures that require substantial energy consumption.

In a recent National Academies report, the Committee on a Research Agenda for a New Era in Separation Science stated that there is a need for breakthroughs in the next generation of separation science. Promising technologies include separations using proteins, electrorefining, ligand-assisted, and counter-current chromatography, as well as machine learning optimization of separation materials. Most of these approaches involve specialty chemicals that are difficult or costly to scale up or adapt to complex feedstock compositions. For example, a significant challenge in electronic waste recycling is the high concentration of residual iron (Fe), which compromises the performance of the separation membrane or device.

Recycling spent batteries and electronics has emerged as a viable option for recovering critical materials. Currently, separating these components from feedstocks relies on adsorbents that bind to specific metal ions, membranes that selectively interact with the target species, and/or toxic solvents that require special treatment for safe disposal. These methods have demonstrated success in some applications but are beset by technical challenges, including the ineffective separation of ions of similar chemistries, the scaling and fouling of membranes, the degradation of adsorbents, the contributions to high carbon dioxide emissions, and the high energy input required for sustaining the driving forces of separation.

One widely used and relatively mild approach is selective precipitation; a feedstock solution is mixed with a precipitating agent, and the insoluble products are recovered. However, batch or bulk precipitation typically creates products that require additional processing steps since the ions of interest tend to have comparable solubilities.

An alternative to batch precipitation may be reaction-diffusion (RD) coupling, where the feedstock solution and precipitating agent are not mixed in the same beaker but rather initially segregated. In contrast to bulk precipitation of all supersaturated components, RD coupling aims to selectively and sequentially precipitate the competing ions according to the interplay of diffusion and nucleation kinetics. The application of RD coupling to the extraction of pure magnesium hydroxide from seawater using the laminar co-flow of the precipitating agent and feedstock solutions was recently demonstrated and published in a paper entitled, “Flow-Assisted Selective Mineral Extraction from Seawater”, by Wang, Nakouzi, and Subban, published in Environmental Science & Technology, Vol. 9, Issue 7, on May 31, 2022.

Another classic example of RD coupling, known as the Liesegang phenomenon, involves placing a concentrated reactant solution in a tube on top of a gel matrix containing a less concentrated salt. As the ions diffuse into the gel, nucleation occurs exclusively in local regions of supersaturation, resulting in oscillations and gradients in the precipitation patterns. While the Liesegang phenomenon has been exploited for controlling nanoscale patterns in materials synthesis, only a handful of studies have explored pattern formation from a mixture of two salts that form competing precipitates.

A need remains for new and improved methods for separating materials that are to be recovered.

### SUMMARY

Embodiments of the invention are directed to a reaction-diffusion approach that provides a simple and scalable pathway to separations, with potential for versatile applications using different types of feedstock. Unlike other methods, the methods of the embodiments of the present invention do not require use of specialized membranes, binding agents, toxic solvents, or electric fields to affect the separation. Embodiments of the present invention use inexpensive and scalable gel medium (such as agarose or gelatin in a cylindrical tube) and a precipitating agent (such as sodium hydroxide, potassium hydroxide, or an oxalate). Embodiments of the invention are not highly specific to a targeted metal ion or feedstock with the reaction-diffusion methods of embodiments of the present invention being broadly applicable to various chemistries. Basic embodiments place a solution containing dissolved ions containing metals in contact with a hydrogel that contains at least one precipitation agent. Diffusion and precipitation reactions are allowed or caused to occur over time to cause physical displacement or separation and thus cause enhanced concentration of the ions at different locations or depths within the hydrogel and thus depletion or reduced concentration in other parts of the hydrogel. In some embodiments, the separated ions are sectioned or segmented into volume regions based on optical characteristics or other characteristics to allow further processing of volume regions having similar characteristics (e.g. similar concentrations of particular precipitated metals or metal salts) to yield metals or metal salts with enhanced concentration or purity. If necessary, still further processing may be performed to create target metals from the metal salts.

Application areas include, for example, recovery of target materials from feedstocks such as recycled batteries and recycled magnets. Other applications include separations from fracking fluids, mining waste, radioactive waste, and the like. In some embodiments, separations may, use gel tubes with precipitants that are tailored for specific feedstock compositions to recover specific materials.

In a first aspect of the invention a reaction-diffusion method for separating at least one target ion that includes a selected metal atom from a solution containing a plurality of different metal containing ions, includes: (a) providing a feedstock solution containing the plurality of different metal containing ions; (b) providing a hydrogel containing at least one precipitating agent; (c) placing the feedstock solution in contact with the hydrogel in a reactor to provide a precipitate containing hydrogel by the different metal-containing ions diffusing into the hydrogel with the at least one target ion reacting with the precipitating agent to form at least one target precipitate containing the at least one target ion such that physical separation of the at least one precipitated target ion from the plurality of different metal containing ions occurs, wherein a concentration of the at least one precipitated target ion is increased relative to at least some of the plurality of different metal containing ions within a volume segment of the participate containing hydrogel.

Numerous variations of the first aspect of the invention exist and include, for example: (1) the concentration of the at least one precipitated target ion within the volume segment having a concentration compared to any other precipitated metal containing ions in the volume segment selected from the group of: (i) at least 50%, (ii) at least 70%, (iii) at least 90%, and (iv) at least 95%; (2) the first aspect or the first variation of the first aspect including the contact surface of the hydrogel and the feedstock having at least one surface selected from the group of: (i) an upper surface, (ii) a lower surface, (iii) a side-facing surface; (3) the first aspect or either of the first or second variations of the first aspect including the reactor having multiple separated volumes of hydrogel with each volume providing at least one contact surface; (4) the first aspect or any Of the first to third variations including the at least one target ion including at least two target ions with each including a different metal wherein the separation provides an increased concentration of a first of the two target ions at one volume segment and an increased concentration of a second of the two target ions at a second volume segment that is different from the first volume segment; (5) the first aspect or any of the first through fourth variations where the at least one target ion includes a metal selected from at least one group of: (i) rare earth metals, (ii) transition metals, (iii) alkali metals, and (iv) lanthanide metals; (6) the first aspect or any of the first through fifth variations where the hydrogel includes a material selected from the group of: (i) agarose, (ii) gelatin, and (iii) chitosan; (7) the first aspect or any of the first through sixth variations where the at least one precipitating agent includes a material selected from the group of (i) hydroxides, (ii) phosphates, and (iii) oxalates; (8) the first aspect or any of the first through seventh variations where the at least one precipitating agent includes at least two precipitating agents; and (9) the first aspect or any of the first through fourth variations where the at least one target precipitate containing the at least one target ion includes at least one metal target atom in a form selected from: (1) an ion containing the at least one target metal, and (2) an atom of the metal in non-ionic form.

In a second aspect of the invention a method for recovering an enhanced concentration of at least one target metal or metal salt from a solution containing a plurality of ions containing different metals including at least one target ion containing the at least one target metal, includes: (a) separating the at least one target ion from a solution containing the plurality of ions, including: 1) providing a feedstock solution containing the plurality of different ions; 2) providing a hydrogel containing at least one precipitating agent; 3) placing the feedstock solution in contact with the hydrogel in a reactor to form a precipitate containing hydrogel having different ions diffused into the hydrogel with the at least one target ion reacting with the precipitating agent to precipitate at least one target ion such that physical separation of the at least one target ion from at least one other ion occurs wherein a concentration of the at least one target ion is increased at at least one location in the participate containing hydrogel wherein the target ion is incorporated into the at least one target metal or metal salt; (b) physically dividing the precipitate containing hydrogel into at least two volume segments having different concentrations of one or more participated metal containing ions; and (c) processing at least one of the at least two volume segments to obtain the at least one target metal or metal salt with an enhanced concentration relative to at least one other precipitated metal or metal salt.

Numerous variations of the second aspect of the invention exist and include, for example: (1) the at least one target metal or metal salt with the enhanced concentration having a concentration, compared to any other precipitated metal or metal containing salt in the volume segment, selected from the group of: (1) at least 50%, (2) at least 70%, (3) at least 90%, and (4) at least 95%; (2) the second aspect or the first variation of the second aspect wherein the contact surface of the hydrogel and the feedstock includes one or more surfaces selected from the group consisting of: (i) an upper surface, (ii) a lower surface, and (iii) a side-facing surface; (3) the second aspect or either of the first or second variations of the second aspect wherein the reactor includes multiple separated volumes of hydrogel with each volume providing at least one contact surface; (4) the second aspect or any of the first to third variations of the second aspect wherein the at least one target ion includes at least two target ions with each including a different metal wherein the separation provides an increased concentration of a first of the two target ions at one volume segment and an increased concentration of a second of the two target ions at a second volume segment that is different from the first volume segment; (5) the second aspect or any of the first to fourth variations of the second aspect where the at least at least one target ion includes at least one metal selected from at least one group of: (i) rare earth metals, (ii) transition metals, (iii) an alkali metals, and (iv) lanthanide metals; (6) the second aspect or any of the first or fifth variations of the second aspect wherein the hydrogel includes a material selected from the group of: (i) agarose, (ii) gelatin, (iii) chitosan; (7) the second aspect or any of the first or sixth variations of the second aspect wherein the at least one precipitating agent includes a material selected from the group of (i) hydroxides, (ii) phosphates, and (iii) oxalates; (8) the second aspect or any of the first or seventh variations of the second aspect wherein the at least one precipitating agent includes at least two precipitating agents; (9) the second aspect or any of the first or eighth variations of the second aspect wherein the at least one target metal or metal salt includes a metal salt with an enhanced concentration that is further processed to provide a quantity of at least one target metal.

The various aspects and embodiments of the invention, set forth explicitly herein or otherwise ascertained from the teachings herein, may address any one of the above objects alone or in combination, or alternatively may address some other object of the invention ascertained from the teachings herein.

Various advantages and novel features of the present invention are described herein and will become apparent to those skilled in this art from the previous and following descriptions. In the preceding and following descriptions, several preferred embodiments and variations have been discussed which illustrate, intra alia, the best mode contemplated for carrying out the invention. As will be realized, the embodiments of the invention are capable of modification in various respects without departing from the spirit of the invention. Accordingly, the drawings and description of the embodiments set forth hereafter are to be regarded as illustrative in nature, and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides a block diagram setting forth a process according to some embodiments of the invention along with three optional process extensions.

FIG. 2A provides before (on the left) and after (on the right) schematic images of an RD method that provides for selective precipitation and separation.

FIGS. 2B-2D provide photographic images of resulting precipitate patterns with individual (Li⁺, Mn²⁺, CO²⁺ and Ni²⁺) salt solutions and a mixed salt solution after 2 hours (FIG. 2B), after 24 hours (FIG. 2C) and after 10 days (FIG. 2D) wherein columns from left to right in each figure provide patterns for Li⁺, Mn²⁺, CO²⁺ and Ni²⁺, and mixed precipitations.

FIG. 2E provides intensity line profiles of the precipitate patterns of the four individual ion solutions of FIG. 2D.

FIG. 2F provides an intensity line profile for the precipitate from the mixed solution of FIG. 2D with the background image being that of the color profile of FIG. 2D turned on its side with the feedstock/hydrogel contact region being to the left and the most distal region from the interface being to the right.

FIG. 2G provides SEM images of precipitate samples from the mixed ion precipitation of FIG. 2D taken from an upper position (near the contract or interface surface) and a lower position deep within the hydrogel as indicated by the image on the left.

FIG. 2H provides molar composition amounts for each of Mn, Co, and Ni from volume segments of the mixed precipitate hydrogel of FIG. 2D at each position (a)-(g) which were sectioned based on optical changes which were believed to be indicative of composition changes of the precipitates at these different levels where the composition amounts were measured by ICP-MS.

FIG. 2I provides a plot of relative change in the elemental composition (or concentration) of Ni comparing the results for the level (a) volume segment of the present RD separation method from a mixed ion feedstock (like that of FIG. 2D) to that obtained from the hydrogel after a non-separating bulk mixing of a similar initial solution with the hydrogel wherein a NaOH concentration of 20 mM was used in all experiments.

FIG. 2J provides a similar chart to that of FIG. 2I but showing the relative change in elemental composition for Mn taken from the level (g) volume segment compared to that from precipitation resulting from bulk mixing.

FIG. 3A provides a photograph of five resulting precipitate columns obtained from a mixed feedstock solution of Li, Mn, Co, and Ni ions with NaOH concentrations of 10 mM, 20 mM, 30 mM, 40 mM, and 50 mM (from left to right) after a 10-day RD separation process.

FIG. 3B provides a plots of molar composition for Li, Mn, Co, and Ni vs volume segments (a)-(g) for each of the five NaOH solutions.

FIG. 3C provides a plot of precipitate density as a function of NaOH concentration with the error bars representing standard deviations from all seven sample positions of each experiment.

FIG. 3D provides two photographs of precipitate patterns with different solution-to-gel volume ratios after 4 days (top image) and 12 days (bottom image).

FIG. 3E provides a photograph of four precipitate columns formed in reactors having different diameters while FIG. 3F provides line profiles of image intensity versus depth in the hydrogel resulting from the precipitate patterns formed in each of the different sized containers of FIG. 3E after five days wherein the line color is FIG. 3F corresponds to the color of the border placed around the respective source column in FIG. 3E.

FIG. 3G provides plots for each of Ni, Mn, and Co of relative change of elemental composition compared to the initial solution as a function of sample position for different NMC types with the green, orange, and purple representing Ni, Mn, and Co, respectively, and with dark to light variations of each color group indicating the NMC combination used and respectively indicating 111, 532, 622, 721, and 811.

FIG. 4 provides photographs of sequences of precipitation patterns for various NaOH concentrations of 10 mM, 20 mM, 30 mM, 40 mM, and 50 mM as shown in the first to fifth columns respectively at each of 2 hours (first row), 1 day (second row), 3 days (third row), and 10 days (fourth row) for single salt solutions of Li, Mn, Co, and Ni ions and a mixed salt solution of the ions from left to right in each image where the reactor tubes had outer diameters of 5 mm and salt compositions of 333 mM LiCl, 100 mM MnCl₂, 24 mM COCl₂ and 24 mM NiCl₂.

FIG. 5A provides a color profile image of a precipitation pattern for an Mn²⁺—only solution where the pattern is on its side with the contact interface to the left and higher depths of the hydrogel to the right.

FIG. 5B provides a line plot of intensity versus position (i.e. depth from the contact surface)

FIGS. 5C-5E provide magnified views of blocked portions of the plot of FIG. 5B showing submillimeter-scale and centimeter-scale periodic variations in the patterns in FIGS. 5C and 5D while the intensity variations from the gel background of FIG. 5E does not show such periodic features.

FIG. 6 provides a micro-Raman spectrum collected on a hydrated precipitate gel in a Mn²⁺—only experiment.

FIG. 7A provides a micro-Raman spectra of six different positions or depths (a)-(f) and a gel position on a dried precipitate gel in a mixed-salt experiment while FIG. 7B provides a photograph of the sample with letters (a)-(f) indicating the approximate locations where the spectra were collected.

FIG. 8A provides an XRD plot of a washed and dried sample with a pure metal salt of Mn²⁺, while FIG. 8B provides a similar plot for a salt of CO²⁺, and FIG. 8C provides a similar plot for Ni²⁺ where a NaOH concentration of 20 mM was used for each experiment.

FIG. 9A provides an image of a mixed salt precipitation column after nine days of precipitation and separation with lines showing imaging locations along the column while FIG. 9B provides an array of SEM images at the indicated locations and with the indicated magnification levels wherein precipitation occurred with the hydrogel containing 20 mM NaOH, and the mixed salt solution formed from 333 mM LiCl, 100 mM MnCl₂, 24 mM COCl₂ and 24 mM NiCl₂.

FIG. 10A provides the photograph of FIG. 3A superimposed with colored boxes indicating segmented sample positions (a)-(g) which are at different depths into the hydrogel for each of the five samples created with respective NaOH concentrations, from left to right, of 10 mM, 20 mM, 30 mM, 40 mM, and 50 mM based on salt solutions containing 333 mM LiCl, 100 mM MnCl₂, 24 mM COCl₂ and 24 mM NiCl₂.

FIGS. 10B-10F provide sideways oriented images for the precipitated hydrogel columns of FIG. 10A for respective NaOH concentrations of 10 mM (FIG. 10B), 20 mM (FIG. 10C), 30 mM (FIG. 10D), 40 mM (FIG. 10E), and 50 mM (FIG. 10F) along with color profiles indicating the regions associated with each sample position and an intensity plot extending through each position which indicates changes from sample region to sample region and changes within each sample region.

FIG. 11A provides two photographs of the resulting precipitate pattern obtained after 5 days with a NaOH composition of 1 mM and a salt solution containing 333 mM LiCl, 100 mM MnCl₂, 24 mM COCl₂ and 24 mM NiCl₂ wherein the right panel provides a magnified view of the upper portion of the left panel to show more detail of the solution/gel interface while FIG. 11B provides similar images when an NaOH composition was 100 mM.

FIG. 12A provides a plot of dried precipitate weight in the gel for the five NaOH concentrations of FIGS. 11A and 11B for segments (a)-(g) while FIG. 12B provides the average precipitate density for each NaOH concentration associated with each segmented volume (a)-(g) using the weights of FIG. 12A in combination with volume of each segment.

FIG. 13A provides, respectively from top to bottom, color profiles of precipitate columns (on their sides) and corresponding plots of intensity at different depths in the precipitate columns after 4 days of precipitation and separation for gel-to-solution ratio values (r) of 3, 2.5, 2, 1.5, and 1 with the total solution volume remaining constant (setting a column height of 40 mm) while varying the hydrogel volume (i.e. height) to provide the ratio targets, wherein the original color profiles were provided in FIG. 3D, wherein the NaOH concentration was 20 mM, wherein the metal salt solution contained 333 mM LiCl, 100 mM MnCl₂, 24 mM CoCl₂, and 24 mM NiCl₂, and wherein some color profiles included part of the tube container (indicated with yellow text) to maintain uniform image length with those added lengths being irrelevant to the experiments.

FIG. 13B provides similar color profiles and plots as FIG. 13A but after 12 days of precipitation and separation wherein the original color profiles for each ratio were set forth in FIG. 3D.

FIG. 13C provides plots of precipitate length as a function of r for different reaction times of 4 days and 12 days.

FIGS. 14A-14H illustrate the effect of gel-to-solution ratio with a constant gel volume after 4 days (FIGS. 14A-14D) and 12 days (FIG. 14E-14H) and where FIGS. 14A and 14B provide photographs of the precipitate patterns after 4 days and with FIGS. 14E and 14F providing photographs of precipitate patterns after 12 days, and where FIGS. 14C and 14D provide color profiles and corresponding plots of precipitate patterns with various r values after 4 days and with FIGS. 14G and 14H providing color profiles and corresponding plots of precipitate patterns with various r values after 12 days, where the r values were varied by keeping a constant height of gel of 60 mm with various heights of the solution including 20 mm (red) and 40 mm (green), and wherein NaOH concentration and metal salt solution molarity was the same as that for FIGS. 13A-13C.

FIG. 15A provides a photograph, from left to right, of the precipitate containing hydrogels from respective solution types NMC 111, NMC 532, NMC 622, NMC 721, and NMC 811 superimposed with colored boxes indicating segmented sample positions while FIGS. 15B-FIG. 15F provide respective color profiles (turned sideways) and corresponding plots of precipitate patterns for NMC 111, NMC 532, NMC 622, NMC 721, and NMC 811 with a constant NaOH concentration of 20 mM being used in the experiments.

FIG. 16A-16E respectively provide molar compositions measured by ICP-MS for NMC 111, NMC 532, NMC 622, NMC 721, and NMC 811 at each of volume segments (a)-(e) for each respective solution as defined in FIG. 15A with an NaOH concentration of 20 mM being used for all experiments.

FIG. 17A-17C provide respective photographs, from left to right, of hydrogel columns with resulting precipitates from single metal salts of 100 mM of Mn²⁺ (FIG. 17A), 100 mM Co²⁺ (FIG. 17B), and 100 mM Ni²⁺ (FIG. 17C) with the gels containing 20 mM NaOH, and the inner diameters of the reactors being 6 mm.

FIGS. 18A-18D provides respective ICP-MS calibration curves for Li, Mn, Co, and Ni.

FIG. 19 provides a table of NMC types including their designations and molar concentration of each ion as used in various experiments of the first series of experiments.

FIGS. 20A-20G provide various images and results associated with a group of precipitation and separation experiments involving Nd and Dy ions, with FIG. 20A providing a schematic of the experimental setup, FIG. 20B providing photographs of the resulting precipitate patterns for individual Dy³⁺, Nd³⁺, and mixed Dy³⁺ and Nd³⁺ salts, with border color coded with magenta, blue, and black, respectively, FIG. 20C providing representative optical micrographs of precipitate crystals in the Dy-only (magenta), Nd-only (blue), and mixed-salt (black) experiments, FIG. 20D providing molar composition amounts of Dy and Nd precipitated salts from a mixed-salt experiment measured by ICP-MS along the length of the precipitate at volume segments (a)-(g) such that changes in the amounts of Dy and Nd salts at different depth levels in the hydrogel may be seen, and with FIGS. 20E-20G providing time-space plots, respectively, of Dy-only, Nd-only, and mixed-salt experiments.

FIGS. 21A-21G provide images and plots of results from using reaction-diffusion coupling with two precipitating agents in the gel, with FIG. 21A providing a photograph of the precipitate pattern with mixed Nd³⁺ and Dy³⁺ in an aqueous solution and a mixture of dibutyl phthalate ions (dbp⁻) and hydroxide ions (OH⁻) in the gel, with FIG. 21B providing four optical micrographs of precipitates at distances from the solution-gel interface as indicated on top of each panel with all scale bars showing a 0.2 mm length, with FIGS. 21C-21F providing intensity averaged for each of the different regions or volume segments and spacing analysis for the large-scale precipitate bands (FIGS. 21C and 21F) and small-scale (FIGS. 21D and 21F) precipitate bands with the hollow circles marking the ratio of two consecutive bands and referring to the right-side Y-axes in FIGS. 21E and 21F, and with FIG. 21G providing EDS maps of a representative precipitate particle acquired from the segment of 0-0.7 cm.

FIGS. 22A-22G providing images and plots showing the results of reaction-diffusion separations from feedstocks containing iron as well as Nd and Dy with FIG. 22A providing a photograph of the precipitate patterns for 5 precipitate containing hydrogels after 5 days for Fe³⁺ concentrations of 10 mM, 20 mM, 40 mM, 100 mM, and 230 mM while maintaining constant concentrations of Nd³⁺ (aq), Dy³⁺ (aq), dbp⁻ (gel), and OH⁻ (gel); FIG. 22B provides measurements of the position, length, and gap of the leading band for each solution condition; FIG. 22C provides optical micrographs of precipitates at the beginning, middle, and end of the gel of the 10 mM Fe³⁺ example of FIG. 22A labeled as segments (i), (ii), and (iii), respectively; FIG. 22D provides powder XRD patterns of precipitates in the different segments of FIG. 22C (solid lines) and pure precipitates for reference (dashed lines); FIG. 22E provides a correlation analysis of EDS maps for segment (i) of FIG. 22C; FIG. 22F provides molar composition along the precipitate from the mixed-salt experiment of FIG. 22C measured by ICP-MS; and with FIG. 22G providing molar compositions at the end of the gel for the different Fe³⁺ concentrations of the examples of FIG. 22A.

FIG. 23 provides micrographs, all at the same scale, at different locations along the gel for the Dy-only experiment (shown with a magenta boundary), Nd-only experiment (cyan), and mixed-salt experiment (black) with the five images in each column approximately corresponding to locations at 5%, 20%, 50%, 80%, and 95% along the precipitate length.

FIGS. 24A, 24C, and 24E provide false-colored images while FIGS. 24B, 24D, and 24F provide line profiles of the individual and mixed salt experiments shown in FIG. 20B with FIGS. 24A and 24B showing results for the Dy-only experiments, FIGS. 24C and 24D showing results for the Nd-only experiment, while FIGS. 24E and 24F provide results for the mixed salt experiment.

FIG. 24G provide segmentation regions for the mixed-salt experiment which were informed by the individual salt experiments where the red line indicates the border between the (a) and (b) segmented regions which was the translucent layer near the solution-gel interface in the Nd-only experiment, and where the blue line indicates the border between the (d) and (e) segmented regions which marked the end of the precipitate region in the Dy-only experiment.

FIGS. 25A and 25B provide micrographs near the solution-gel interface at lower and higher resolutions using a 4× objective lens and a 10× objective lens, respectively, for a Dy-only precipitation, FIGS. 25C and 25D provide similar micrographs for an Nd-only precipitation, and FIGS. 25E and 25F provided similar micrographs for a mixed-salt precipitation.

FIGS. 26A-26C respectively provide the time-space plots as shown in FIG. 20E-20G with the addition of superimposed growth fronts for their respective Dy-only, Nd-only, and mixed-salt precipitations.

FIG. 27 provides a photograph of the phase-contrast X-ray imaging setup.

FIG. 28A provides two sets of photographs of the precipitation patterns for Nd-only solutions in a left panel with NdCl₃ concentrations in the solutions of 10, 20, 30, and 40 mM, respectively from left to right and mixed salt solutions in a right panel with a constant DyCl₃ concentration of 10 mM and increasing concentrations of NdCl₃ from 0 to 40 mM in 10 mM increments from left to right while FIGS. 28B-28J provide time-space plots of for various precipitation experiments of FIG. 28A based on the salt concentrations shown at the top of each image.

FIGS. 29A-29C provide a matrix of photographs of precipitations from solutions containing salts of (1) 10 mM Fe³⁺, (2) 40 mM Nd³⁺ and 10 mM Dy³⁺, or (3) a combination of 10 mM Fe³⁺, 40 mM Nd³⁺, and 10 mM Dy³⁺ and gels containing one or more precipitants or reactants of (a) 10 mM dbp⁻, (b) 30 mM OH⁻ or (c) 10 mM dbp⁻ and 30 mM OH⁻ where the tube diameter was 5 mm and the reaction time was 5 days.

FIG. 30 provides a time-space plot of the mixed-salt experiment of FIG. 29C with a gel containing two precipitation reagents with an overlaid square root fit curve in red that deviates after the formation of the last periodic bands at x=1.4 cm.

FIG. 31A provides width measurements for the large-scale bands while FIG. 31B provides measurements for the small-scale bands which show that the ratio of two consecutive bands varied for both the large-scale and small-scale groups with the variations in the large-scale bands possibly being due to the inhomogeneous distribution of particles in each band whereas conventional Liesegang bands contain uniform layers of precipitates.

FIG. 32A provides stitched micrographs of the precipitate pattern shown in FIG. 21A which shows that the micro-scale bands overlapped with the last two large-scale bands (n=13 and 14) while FIG. 32B plots particle size as a function of band number for the large-scale band group.

FIG. 33 provides molar composition of Dy and Nd from the mixed salt experiment of FIG. 21A from seven segments (a)-(g) along the precipitate pattern as measured by ICP-MS.

FIG. 34 provides a Raman spectrum of a volume segment sampled at the solution-gel interface with a solution having an Fe³⁺ starting concentration where the sharp peaks at 222, 287, and 403 cm⁻¹ indicate a possible match with goethite a-FeO(OH).

FIG. 35A provides a photograph of a precipitation column with brackets showing upper, middle and lower volume segment positions, while FIGS. 35B-35D provide EDS maps of the three segmented samples for a solution concentration of [Fe³⁺]=10 mM wherein the images in FIG. 35B were used for the correlation analysis shown in FIG. 22E and wherein the analysis was performed by converting the false-colored EDS maps to grayscale, cropping them to a region of interest, and computing the pairwise correlation coefficients using MATLAB.

FIG. 36A provides a photograph of resulting precipitation patterns for various Fe concentrations superimposed with colored bars indicating the lower boundaries of each segmented sample.

FIGS. 36B-36E provide molar compositions along the precipitate columns from mixed-salt experiments with a mixed-reactant gel measured by ICP-MS for iron concentrations of 20 mM, 40 mM, 100 mM and 230 mM respectively for the FIG. 22G positions.

### DETAILED DESCRIPTION OF THE INVENTION

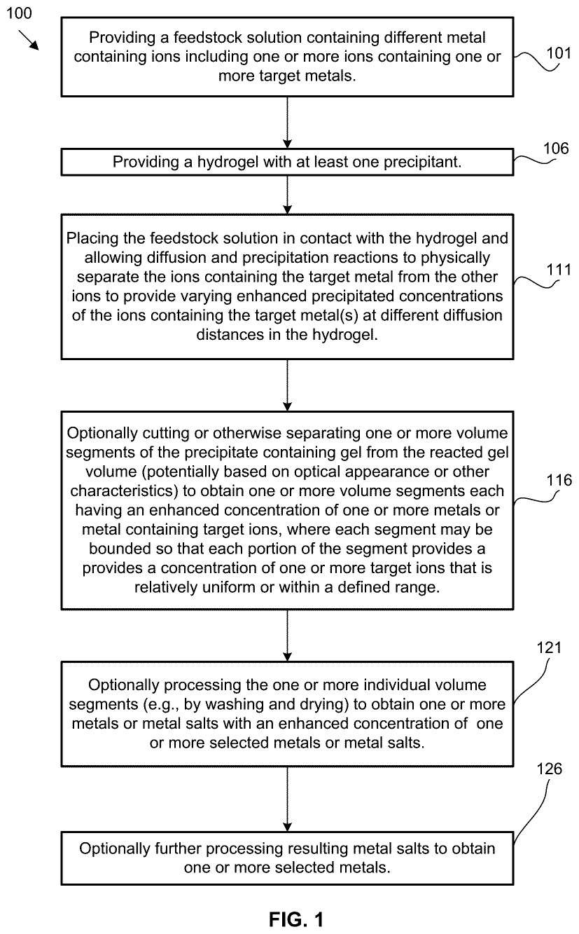

FIG. 1 provides a block diagram of a process 100 according to some embodiments of the invention. The process starts with block 101 which calls for providing a liquid feedstock including different metal-containing ions with one or more kinds of ions containing target metal atoms. From block 101 the process moves to block 106 which calls for providing a hydrogel along with at least one precipitant. From block 106 the process moves to block 111 which calls for placing the feedstock solution in contact with the hydrogel and allowing diffusion and precipitation reactions to physically separate the ions containing the one or more target metals from the other ions to provide a varying enhanced precipitated concentrations of the ions containing the target metal or metals at different diffusion depths in the hydrogel. From block 111 the process optionally moves forward to block 116 which calls for cutting or otherwise separating one or more volume segments of the precipitate containing gel from the rest of the reacted volume (potentially based on optical appearance or other characteristics) to obtain one or more volume segments each having an enhanced concentration of one or more target metals or metal containing ions. From block 116 the process optionally moves to block 121 which calls for processing one or more individual volume segments (e.g. by washing and drying) to obtain one or more metals or metal salts with an enhanced concentration of one or more selected metals or metal salts. From block 121 the process optionally moves forward to block 126 which calls for further processing of the metal salts to obtain one or more selected metals. Numerous variations of the process of FIG. 1 are possible and include, for example, variations in processing temperatures, pressures, and times, variations in the base hydrogel being used, variations in precipitants, variations in concentrations of hydrogels, precipitants, and/or feedstocks used, locations and sizes of contact surfaces between the hydrogel and the feedstock, and the like.

### Introduction to a First Series of Experiments: Battery Electrode Material Separation

A first series of experiments and tests were performed to demonstrate the separation of critical metal ions based on the coupling of ion diffusion and precipitation kinetics. A model feedstock solution simulating dissolved battery electrodes was placed on top of a hydrogel loaded with a precipitating agent, namely, sodium hydroxide. As the lithium, manganese, cobalt, and nickel ions diffused into the gel, a gradient of precipitates formed along the length of the reactor. Elemental analysis of the spatially distributed precipitates showed the enrichment of nickel near the gel-solution interface, followed by the formation of an almost pure (>96%) manganese product further along the reactor. Optimization experiments revealed that a sodium hydroxide concentration of 10 mM and a gel/solution volume ratio of 2:1 favored efficient separations. The robustness of the method was demonstrated in four out of five feedstock compositions of typically used battery cathodes. These experiments provide paradigm shift for critical materials separations that does not require specialty chemicals, binding agents, membranes, or toxic solvents. The subject matter of this first set of experiments was set forth in a paper by the inventors, published on Nov. 22, 2023, entitled “Reaction-Diffusion Coupling Facilitates the Sequential Precipitation of Metal Ions from Battery Feedstock Solutions”, in Environmental Science & Technology Letters, Vol 10, Issue 12 (https://pubs.acs.org/doi/10.1021/acs.estlett.3c00754) which is hereby incorporated herein by reference.

### Methods and Materials for the First Series of Experiments

Gel Preparation: A gel solution (2.0 wt %) was prepared by dissolving 0.2 g of agarose powder in 10 mL of DI water in a water bath (90° C.). Aliquots containing 1 mL of the hot gel solution were added to various volumes of 1.0 M NaOH solution and DI water and stirred in a water bath until homogeneous. The hot NaOH-containing gel solution with 0.5 wt % agarose was subsequently transferred to glass tubes (inner diameter 4.2 mm, length 178 mm) and cooled at room temperature, allowing agarose gelation. The NaOH concentration in the gel was varied between 1 and 100 mM.

Precipitation Experiments: Solutions containing individual or mixed metal salts of 333 mM LiCl, 100 mM MnCl₂, 24 mM CoCl₂, and 24 mM NiCl₂ were added in glass tubes on top of the NaOH-containing gel with a typical gel-to-solution volume ratio of 3. For our systematic measurements, this ratio was varied from 1 to 3, while the tube diameter was varied between 4 and 14 mm. The tubes were then sealed with plastic caps. All experiments were performed at room temperature for about 10 d. Photographs of the resulting samples were captured using a Nikon D5500 camera equipped with a NIKKOR 18-55 mm f/3.5-5.6G lens. The image data were analyzed using custom scripts in MATLAB (MathWorks, R2022b). For the bulk mixing experiments, 5 mL of the mixed salt solution was mixed directly with 5 mL of 20 mM NaOH solution in a glass vial and stirred for 4 h.

Characterization: The precipitate samples were washed, air-dried, and then digested in concentrated HNO₃ overnight. The concentrations of metal ions in the digested samples were determined by inductively coupled plasma mass spectrometry (ICP-MS, PerkinElmer NexION 2000). The mass of dried samples was measured using an analytical balance (XSR105, Mettler Toledo). The samples were manually ground using a mortar and pestle for the powder X-ray diffraction (XRD) measurements using a Bruker D8 Discover Microfocus Diffractometer at an average scan rate 0.37 deg/s. The samples were sputter-coated with Au/Pd at a 60/40 ratio before characterization using scanning electron microscopy (SEM, FEI Sirion XL30). Raman spectra were collected on hydrated and dried gel samples using a micro-Raman spectrometer (LabRam HR, Horiba) with an excitation wavelength of 632.8 nm at low powers (10 μW).

Chemicals: The chemicals used in these experiments included: (1) Agarose (Type I, low EEO, Sigma-Aldrich), (2) sodium hydroxide (NaOH, Fisher Chemical), (3) lithium chloride (LiCl, Sigma-Aldrich), (4) manganese chloride (MnCl₂·4H₂O, J. T. Baker-Aldrich), (5) cobalt chloride (CoCl₂·6H₂O, Sigma-Aldrich), (6) nickel chloride (NiCl₂, Sigma-Aldrich), and (7) nitric acid (TraceMetal grade, Fisher Chemical). These chemicals were used as received. All solutions were prepared with ultrapure water filtered by a Milli-Q IQ 7000 water purification system (resistivity, 18.2 MΩ·cm).

Separation experiments from various nickel, manganese, and cobalt (NMC) feedstocks: For the separation experiments with Ni-rich compositions, the Ni²⁺ concentration in these solutions were kept constant at 100 mM, and various Mn²⁺ and CO²⁺ concentrations were used to simulate different NMC types including 111, 532, 622, 721, and 811. Solutions containing mixed metal salts of NiCl₂, MnCl₂ and COCl₂ (various concentration) were added on top of the gel containing 20 mM NaOH with a gel-to-solution volume ratio of 3. The solution composition is listed in the Table of FIG. 19.

Sample treatment: After 10 days of reaction, the bottom end of the glass tube was carefully broken. The precipitate-containing gels were pushed out of the tube as a whole and then segmented into smaller pieces (volumes) using a thin spatula. The gel segments were washed in DI water in a hot water bath and centrifuged three times to remove agarose and soluble salts. The washed samples were dried under ambient conditions overnight.

### Details and Results for the First Series of Experiments

In these experiments, reaction-diffusion coupling was used to achieve selective precipitation from a multicomponent feedstock solution with the solution containing mixed metal salts, namely Li—Mn—Co—Ni chlorides. These dissolved mixed metal salts are similar to what is found in a battery feedstock. The solution was placed in a cylinder on top of an agarose hydrogel layer loaded with a precipitant. The precipitant in this experiments was sodium hydroxide. As the metal ions diffused into the gel, crystallization took place in regions of high supersaturation, which locally depleted the ions, which were then subsequently replenished by diffusive flux. This interplay of diffusion, nucleation, and growth kinetics results in a spatial unfolding of unique nonequilibrium conditions along the length of the reactor.

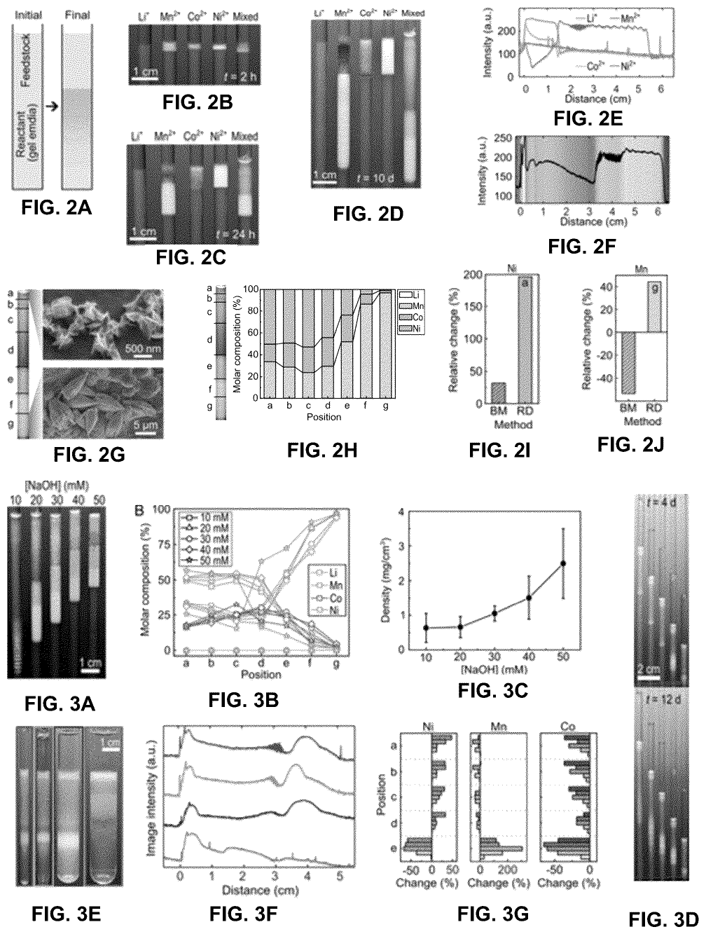

FIG. 2A provides a schematic representation of the experimental setup used in this first set of experiments with the left most column showing an initial system configuration while the right most column shows the configuration after precipitation and separation. At the start of the experiment, ions diffused primarily from the solution into the gel layer due to the larger concentrations which was approximately 1 order of magnitude. Accordingly, precipitation began near the solution-gel interface and propagated further into the gel medium. The coupling of diffusion and reaction kinetics yields an inhomogeneous distribution of the precipitates along the reaction medium as is schematically illustrated in the right most column of FIG. 2A where optically distinct regions are formed at different depths from the boundary interface. In alternative embodiment, the solution need not be located above the hydrogel but may be located below, to the side of it, or in some other configuration providing at least a single interface surface if not multiple surfaces. In still other embodiments, multiple regions of hydrogel may be provided with a corresponding surface interfaces so long as sectioning of the different volume segments of the hydrogels can be obtained for further processing.

It is worth noting that one or more differences exist between embodiments of the invention as illustrated in the experiments described herein and conventional Liesegang experiments. As a first example, in the current set up a mixture of metal salts is used instead of a single precipitating metal ion. As a second example, the precipitating metal ions are in the aqueous solution and their precipitating counterions are in the gel rather than the inverse. These differences allow for separating metal ions from aqueous feedstocks of typical concentrations and compositions that might be involved in a separation or recovery process.

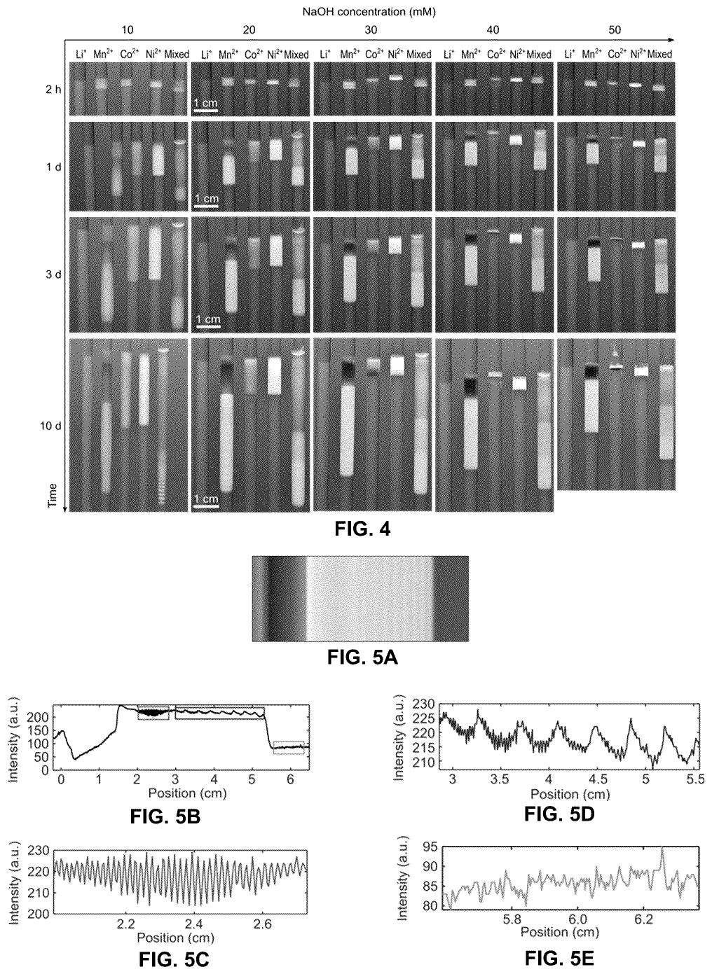

A series of experiments were performed using individual and mixed salt solutions of LiCl, MnCl₂, CoCl₂, and NiCl₂ at concentrations of 333, 100, 24, and 24 mM, respectively. The mixture included all the metal ions at these concentrations and served as a model feedstock comparable to dissolved electrodes, such as Li_{1.2}Mn_{0.54}Co_{0.13}Ni_{0.13}O₂, which is commonly used as cathode material in lithium-ion rechargeable batteries. Within 2 hours precipitation from the Mn²⁺, CO²⁺, Ni²⁺, could be observed from the model feedstock solutions but not from the Li⁺ solution since lithium hydroxide is undersaturated at these concentrations. This can be seen in the image of FIG. 2B. As the reactions progressed, the precipitates continued to grow in length and developed complex patterns with variations in opacity and color, indicating the formation of gradients in chemical composition and crystallography. These can be seen in FIG. 2C, FIG. 2D and FIG. 4.

To analyze the precipitate patterns, 1D intensity profiles as can be seen in FIGS. 2E and 2F along the length of each tube of FIG. 2D. The line profile (shown in FIG. 2E of the Li⁺—only experiment (left most column of FIG. 2D) showed a substantially constant background due to the absence of precipitate. Note that the sharp spikes were caused by light-scattering particles at the outer walls of the glass tubes. The Ni²⁺—only experiment resulted in the second the separation pattern shown in the second column from the right of FIG. 2D and produced a relatively uniform white precipitate extending about 1.5 cm as can be seen in FIG. 2D and as reflected in the Ni plot of FIG. 2E. In contrast, the Co²⁺—only experiment resulted in the separation pattern seen in the middle column of FIG. 2D and showed an initially relative thin light pink precipitate, followed by a blue-to-green gradient within about 1.4 cm and a narrow bright green precipitate band at about 1.6 cm. These color changes were accompanied by an initial increase in the intensity of the line profile for cobalt plot in FIG. 2E, followed by a gradual and then a sudden decrease near the precipitation front. Similar Co-based precipitates with color gradients were previously observed in Hele-Shaw cells and ascribed to various polymorphs of cobalt hydroxide. For the Mn²⁺—only experiment the resulting precipitation pattern is seen in the second column from the left in FIG. 2D, with an initial light-to-dark brown gradient being produced within about 0.3 cm of the interface surface, followed by a dark-to-light brown gradient within 1.5 cm and a sharp transition to a white precipitate that extended to 5.5 cm. This latter Mn segment of FIG. 2E was characterized by two distinct regimes with oscillatory features of 0.02 and 0.4 cm in wavelength as scan be seen in FIGS. 5A-5E and most specifically in FIGS. 5C and 5D respectively. These oscillations did not follow the spacing law for conventional Liesegang patterns but were rather similar to the equidistant precipitate bands found in a mechanically responsive gel system. The experiment with the mixed-salt solution produced a complex precipitate pattern as can be seen in the right most column of FIG. 2D and in the intensity profile of FIG. 2F. The pattern extends approximately 6.3 cm from the interface surface which is significantly farther than the single-salt experiments due at least in part to the larger total metal ion concentration. The mixed salt pattern included brown, blue, and eventually white precipitates characterized by Liesegang oscillations comparable to those of the Mn²⁺-only case. These results showed that the presence of mixed salts generated complex patterns, beyond a linear summation of the single salt cases.

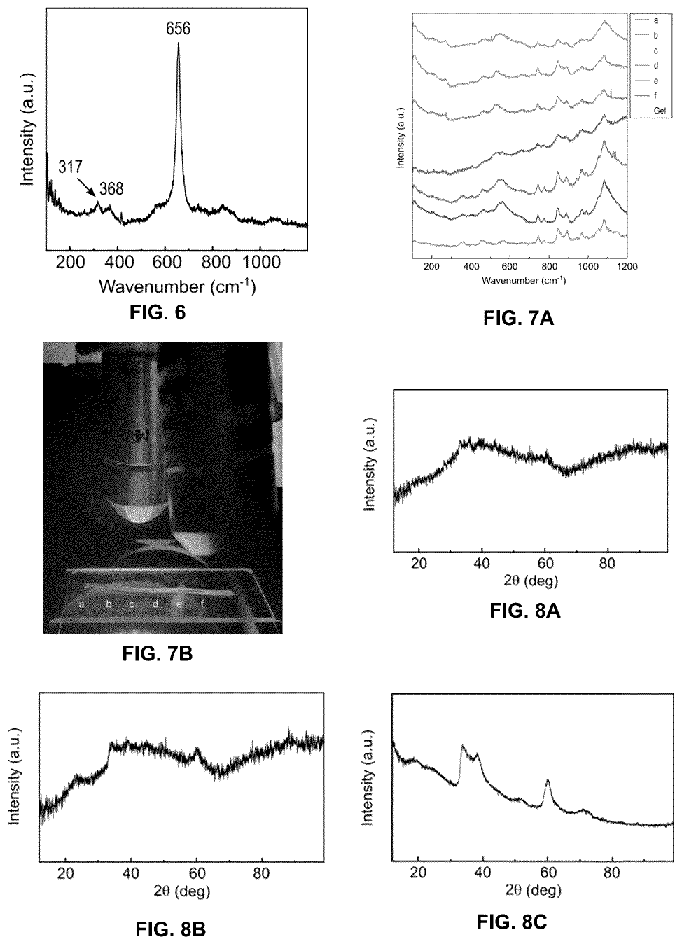

Using in situ micro-Raman spectroscopy, we identified the α-Mn₃O₄ polymorph in the Mn²⁺—only experiment based on the sharp characteristic peak at 656 cm⁻¹ and lower-intensity peaks at 317 and 368 cm⁻¹ as shown in FIG. 6; however, no conclusive resolution of the products formed in the mixed-salt system was obtained due to the strong background signal of the agarose gel and the drying effects when the system was exposed to laser radiation for extended periods of time. FIG. 7A provides micro-Raman spectra for the gel alone and for the precipitate containing gel at different levels (a)-(f) where the approximate (a)-(f) levels are shown in FIG. 7B.

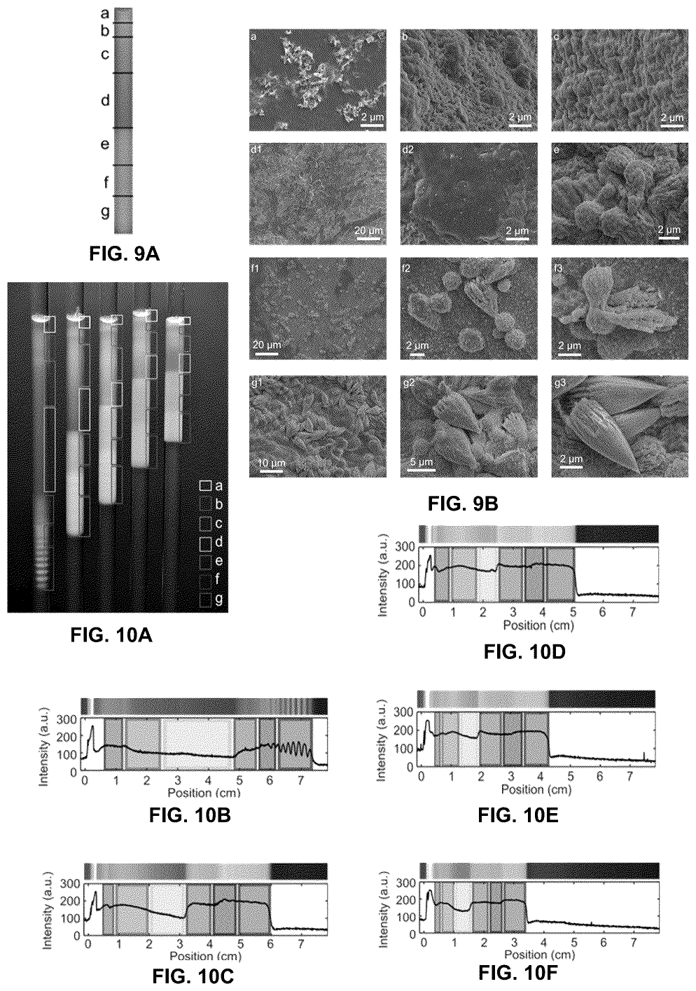

XRD analysis of the various products showed broad peaks and low intensities, suggesting a mixture of amorphous and nanocrystalline materials for the Mn, Co, and Ni single metal experiments as can be seen respectively in FIGS. 8A-8C. These variations were accompanied by changes in the precipitate morphology from microscale platelets to cone-shaped structures as can be seen in the SEM images of FIG. 2G and FIG. 9B.

ICP-MS measurements were performed using digested segments of the gel to quantify the elemental composition of the products in the mixed-salt experiment. The selection of gel segments was informed by the precipitate colors and features in the 1D line profile of the mixed precipitate result of FIG. 2F.

The chemical composition of the mixed metal precipitates showed a gradient along the length of the reactor, with enriched nickel content at the beginning of the reactor, cobalt in the intermediate region, and ultimately producing almost pure manganese (hydroxide) toward the opposite end as shown in FIG. 2H. FIG. 2H provides a vertical column to the left showing regions (a)-(g) from top to bottom along the columnar reactor along with a stacked plot to the right summarizing molar composition percentages for each of Mn, Co, and Ni at each position (a)-(g) along the column depth.

The initial three segments showed significant enrichment of nickel, up to approximately 50% by mol, despite nickel constituting only 6.5% of the feedstock. These segments also included 12-20% cobalt and 22-32% manganese.

The manganese ratio increased significantly in the latter growth stages, reaching 96.5% purity in the final segment of the precipitate gel s shown at position (g) of FIG. 2H. Concurrently, the precipitate transitioned from a Co/Ni ratio of 0.3 near the solution/gel interface (position a) to 1.9 at position (g).

As a control experiment, bulk mixing of solutions was performed with the same concentrations to obtain a precipitate mixture with a Mn:Co:N molar ratio of 30:33:37. The approximately equal concentration of Mn, Co, and Ni is not surprising given the relatively small differences (2 orders of magnitude) in Ksp values of the respective hydroxide precipitates. FIGS. 21 and 2J quantify the molar compositional change in the precipitate relative to the initial salt mixture. For Ni, the enrichment in the RD method at position (a) was six times higher than bulk mixing. For Mn, the RD method at position (g) showed an enrichment of 44.2% culminating in the extraction of a pure Mn product, while bulk mixing yielded a depletion of 53.5% in a precipitate mixture that included significant portions of Ni and Co. Specifically, 12.7% of the total Mn in the feedstock solution was recovered as a high-purity product in the final segment at position (g). We note that the recovery rate of our method is lower than some reported methods, partially due to the lower NaOH concentration compared to the metal-salt-containing feedstock. However, the selective precipitation of Mn was achieved without requiring organic solvents, heating, or specialty chemicals.

This separation was accomplished without the use of specialty chemicals, complex membranes, organic solvents, binding agents, high temperature processing, or electric fields. The metal ion mixture was simply placed on top of a hydrogel loaded with sodium hydroxide and allowed to develop such that the various metal oxides were formed in order of their precipitation rates as they diffused into the gel. This example and the concepts illustrated provide a significant step forward toward critical element recovery.

### Systematic Optimization of Control Parameters for the First Series of Experiments

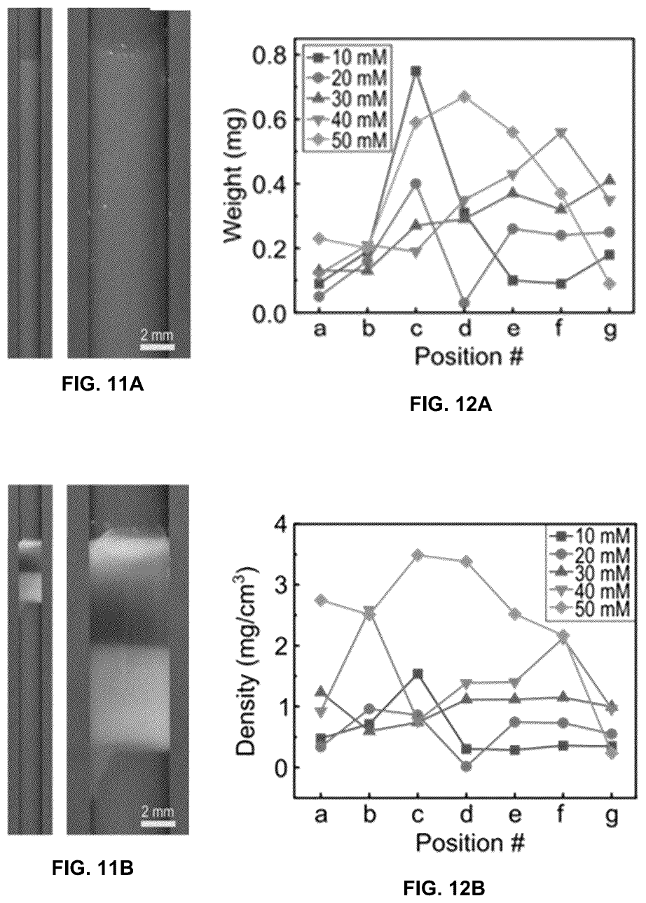

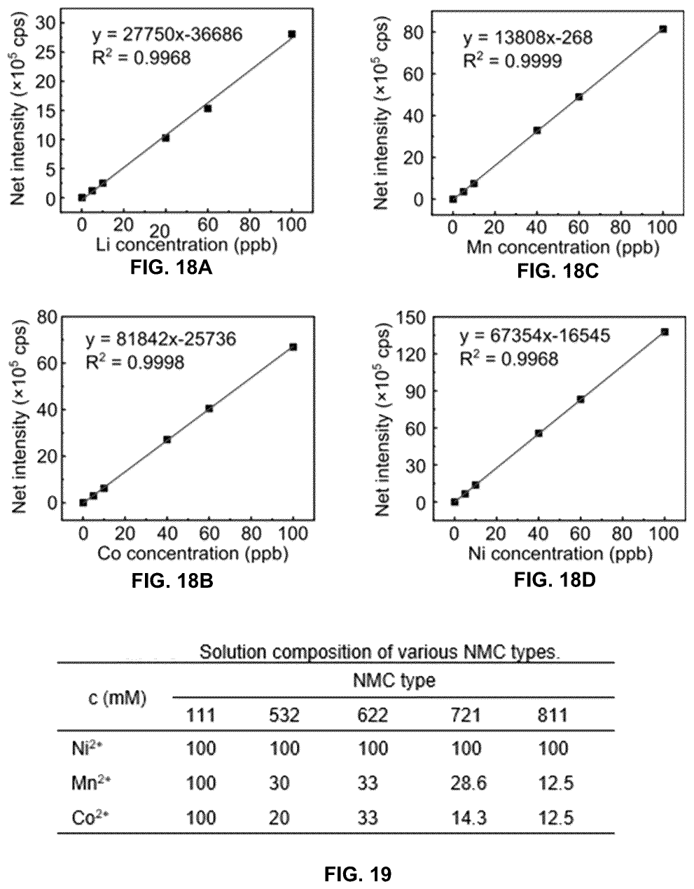

To optimize the separation efficiency, the role of multiple parameters was investigated, namely, the concentration of the precipitating agent, the gel-to-feedstock volume ratio, and the size of the reactor. A series of experiments with NaOH, as the precipitant, were performed with NaOH ranging from 10 to 50 mM while keeping the feedstock concentration constant. It was found that an increase in NaOH concentration yielded a smaller precipitate length in both individual salt experiments and mixed salt experimental results set forth in FIG. 3A and in the various examples of FIG. 4. ICP-MS measurements of the Mn/Co/Ni ratios in the mixed-salt precipitates showed almost identical trends as a function of the NaOH concentration as can be seen in FIG. 3B after analysis in reference to the calibration curves in FIGS. 18A-18D. Ni enrichment near the solution-gel interface was consistently observed as was >94% Mn toward the end of the gel medium. Positions for sample segmentation were informed by the precipitate color and features in line profiles which are observable in the image of FIG. 10A and in the combined image and line profiles of FIGS. 10B-10F. At a higher NaOH concentration of 100 mM, the precipitate extended only about 1.3 cm (after 5 days), which was not optimal for separations (FIG. 11B) while at the opposite extreme where the NaOH concentration was 1 mM, little precipitate was observed in the gel (FIG. 11A). As such, 10 mM was identified as sufficiently effective for sequential separation, even though an increase in NaOH concentration, on average, yielded denser precipitates as can be ascertained from FIG. 3C and FIG. 12A-12B where density was calculated as the mass of metal ions per gel volume.

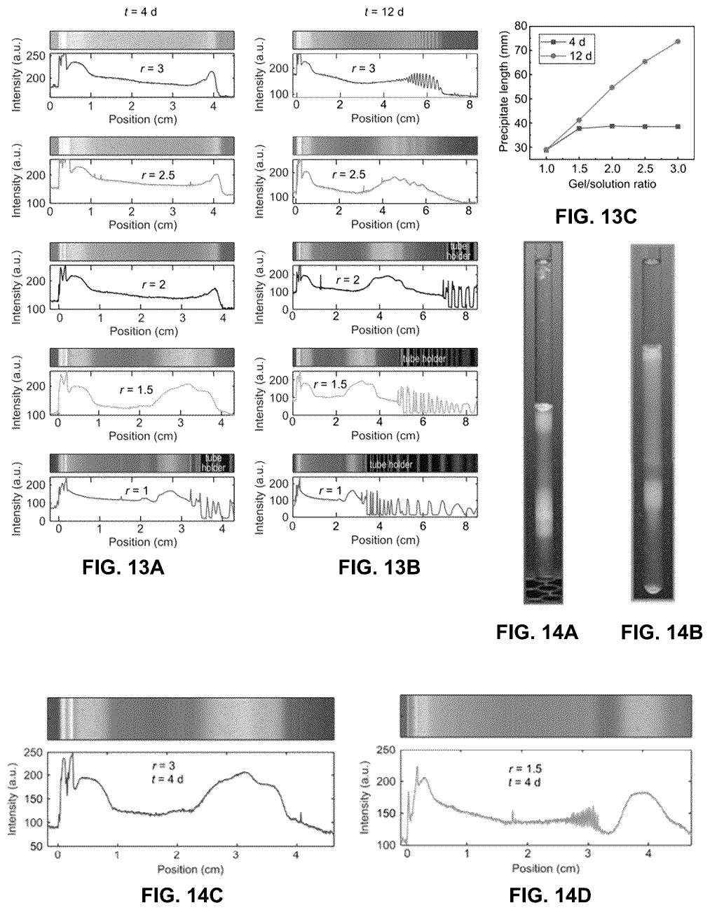

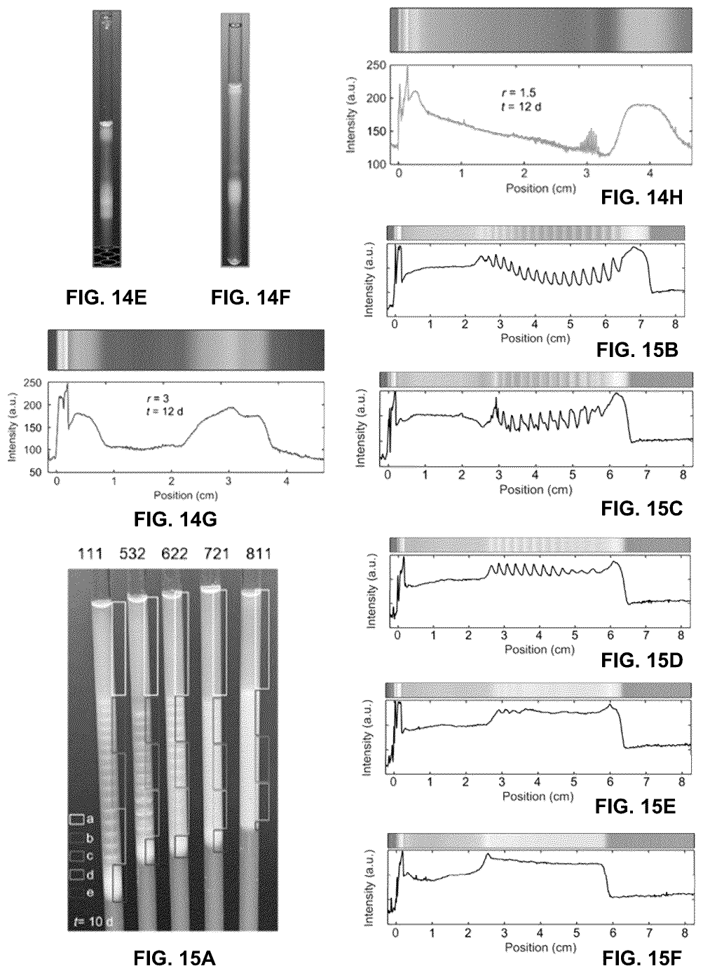

The effect of the gel-to-solution volume ratio “r” was also studied. Decreasing the gel volume while keeping the solution volume constant yielded precipitate layers of similar length in the early growth stages but less precipitate as time progressed as can be seen in FIG. 3D and FIG. 13A-13C. High similarity in the color gradients and intensity profiles suggest a minimal effect of “r” in separation. In addition, varying “r” from 3 to 1.5 by decreasing the solution volume while keeping the gel volume constant also yielded nearly identical precipitate patterns as can be seen in FIG. 14A-14G. Overall, an effective “r” value for further experimentation was identified as 2 for the current feedstock.

Experiments for potentially scaling up the process were performed using increasing container size (i.e., diameter) as can be seen in the variations of FIG. 3E. Similar precipitate patterns were obtained in different cylindrical containers with inner diameters ranging from 4 to 14 mm as indicated by plots of the line profiles in FIG. 3F with the line color corresponding to the reactor bounding block colors shown in FIG. 3E. The darker precipitate color in the largest container is attributed to a larger gas permeability in the polystyrene container compared to the other glass tubes. These results show that larger amounts of product can be recovered without compromising the purity by increasing the reactor dimensions. By utilizing multiple large reactors or creating new reactor designs that provide large interfacial areas, the production rate can be increased for potential applications.

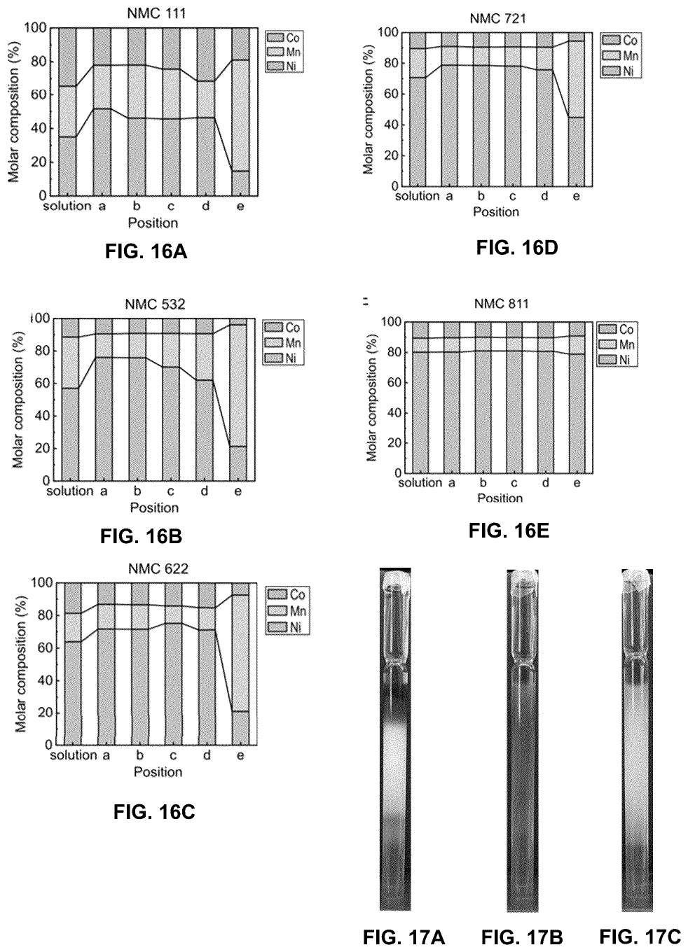

To test the versatility of the RD method, experiments on a variety of feedstock compositions commonly found in NMC batteries with Ni-rich contents were performed where the NMC ratios were set at 1:1:1, 5:3:2, 6:2:2, 7:2:1, and 8:1:1. We measured the Ni/Mn/Co ratios in the initial mixed-salt solutions (see the compositions in the table of FIG. 19) and in different segments along the length of the reactor as can be seen in FIGS. 16A-16E. A significant enrichment of manganese toward the end of the gel medium was found in four of these five cases, namely, NMC 111, 532, 622, and 721, even though Ni²⁺ was more (or equally) concentrated than Mn²⁺ and CO²⁺ in the initial solutions. In the 811 ratio experiment, nearly constant ratios of Ni/Mn/Co were found in the positions between the solution/gel interface and the end of the gel as can be seen in FIG. 16E. These findings show that the enrichment of manganese is a robust result from various feedstock compositions, not simply due to the higher initial concentration of manganese. The distribution of Ni-rich to Mn-rich precipitates agrees with the trend in the hydroxide solubility constants with 5.5×10⁻¹⁶ for Ni(OH)₂, 5.9×10⁻¹⁵ for Co(OH)₂, and 4.6×10⁻¹⁴ for Mn(OH)₂. However, control experiments with individual salts of 100 mM Ni²⁺, 100 mM CO²⁺, and 100 mM Mn²⁺ showed similar precipitate lengths as shown in FIGS. 17A-17C.

In conclusion, with regard to this first group of experiments, proof-of-concept for the enrichment and separation of critical materials using RD coupling was obtained. Starting from model feedstock solutions of battery electrodes, sequential precipitation of nickel-rich products followed by almost pure manganese products (94-97%) along the length of the reactor was obtained. Importantly, these results did not require specialty chemicals such as ligands, membranes, or solvents that are designed to extract target ions. The precipitate product can be potentially used in other processes to produce metallic materials which may be catalytic materials. It is anticipated that the processes of the embodiments of the invention will have a high degree of versatility and applicability to a variety of feedstock chemistries, for which bulk precipitation is already used at an applied scale. For example, prefilled tubes loaded with reactive gels can be optimized for specific feedstocks, analogous to the use of chromatography columns in other areas of chemical separations. Feedstocks may, for example, include electronic waste, acid mine drainage, geothermal brines, or radioactive waste. Gels, for example, may be tailored to change their porosity by tuning agar concentration, changing gel chemistry to other hydrogels such as gelatin or silica, or functionalizing the gels using cross-linkers.

### Introduction to a Second Series of Experiments: Magnet Material Separation

As with the first series of experiments the second series of experiments is directed to demonstrating separation of critical metal ions based on the coupling of ion diffusion and precipitation kinetics. This second set of experiments is directed to separating iron, neodymium, and dysprosium ions from model feedstocks of permanent magnets, which are typically found in electronic wastes. Feedstock solutions were placed in contact with a hydrogel loaded with potassium hydroxide and/or dibutyl phosphate, resulting in complex precipitation patterns as the various metal ions diffused into the reaction medium. Specifically, the separation of up to 40 mM of iron from the feedstock was followed by the enrichment of 73% dysprosium, and the extraction of >95% neodymium product at a further distance from the solution-gel interface. These experiments further validated reaction-diffusion coupling as an effective and versatile approach for critical materials separations, without relying on ligands, membranes, resins, or other specialty chemicals.

### Methods and Material for the Second Series of Experiments

Chemicals and materials: The chemicals used in these experiments include: (1) Agarose (type I, low electroendosmosis [EEO], Sigma-Aldrich), (2) dibutyl phosphate (Kdbp, [CH₃[CH₂]₃]₂HPO₄, 97%, Thermo Scientific Chemicals), (3) potassium hydroxide, (KOH, Fisher Scientific), (4) neodymium chloride hydrate (NdCl₃·H₂O, 99.9% rare earth oxide [REO], Thermo Scientific Chemicals), (5) dysprosium chloride(DyCl₃, anhydrous, 99.9% Dy, Fisher Chemical), and (6) nitric acid (HNO₃, Trace Metal grade, Fisher Chemical). These material were used as received. All solutions were prepared with deionized water (resistivity, 18.2 MΩcm) filtered by a water purification system (Milli-Q IQ 7000).

Gel preparation: In a typical experiment, 0.2 g of agarose powder was dissolved in 10 mL of DI water in a hot water bath at about 90° C. Then 2.5 mL of the hot agarose solution (2 wt %) was mixed with a preheated 1.0 M Kdbp (and/or 1.0 M KOH) solution and hot DI water to yield the desired reactant concentration of 10 mM Kdbp (and/or 30 mM KOH) with 0.5 wt % agarose. The mixed liquids were stirred in the hot water bath until homogeneous, subsequently transferred to glass tubes (inner diameter 4.2 mm, outer diameter 5 mm, length 178 mm), and cooled at room temperature for further use.

Diffusion experiments and X-ray imaging: 0.5 mL of 1.0 M NdCl₃ or DyCl₃ were added to a cuvette containing agarose gel (0.5 wt %). X-ray radiography was used to track the diffusion of REEs into the gel. Cuvettes were placed approximately 10 cm in front of a digital X-ray detector (Shad-o-box 6k HS, 49-micron pixels). The detector was approximately 2 m from the source (Comet MXR-160HP/11, operated with a 1 mm focal spot). Images were acquired with an X-ray endpoint energy of 160 kV and a current of 2 mA, and each image was averaged from 120 frames (0.5 seconds exposure time each). All images were flat and dark corrected, such that the resulting intensities represented the fraction of radiation transmitted. The ion concentration was determined from the image contrast as

$$C = - ln ( int )$$

Where C and int represent the ion concentration and image intensity, respectively, and normalized against the initial image contrast for the bulk solution at 1.0 M.

Precipitation experiments: Solutions of individual or mixed salts of FeCl₃, NdCl₃, and DyCl₃ were added in the glass tubes containing the reactant-loaded gel with a gel-to-solution volume ratio of 3 (solution length 40 mm, gel length 120 mm). All experiments were performed at room temperature for about 5 days. The progress of precipitate formation was recorded using a digital single-lens reflex (DSLR) camera (Nikon D5500) controlled by a personal computer (PC) and digiCamControl software. The collected image data were analyzed using custom scripts in MATLAB (MathWorks, R2022b).

Characterization: At the end of the time-lapse recording, micrographs of the samples were collected using an inverted optical microscope (AmScope IN480T) and a digital camera (Nikon D5500). Then, the precipitate samples were extracted from the glass tubes, washed in hot water, and air-dried for further characterization using powder-X-ray diffraction (XRD, Bruker D8 Discover Microfocus diffractometer), Raman microscope (Renishaw InVia, excitation wavelength, 785 nm), scanning electron microscopy (SEM, FEI Sirion XL30), and energy-dispersive X-ray spectroscopy (EDS, Oxford Instruments). In addition, the precipitate samples were digested in concentrated nitric acid (HNO₃, 70 wt %), and their elemental composition was measured by inductively coupled plasma mass spectrometry (ICP-MS, PerkinElmer NexION 2000).

### Details and Results for a Second Series of Experiments

### Sequential Precipitation of Neodymium and Dysprosium

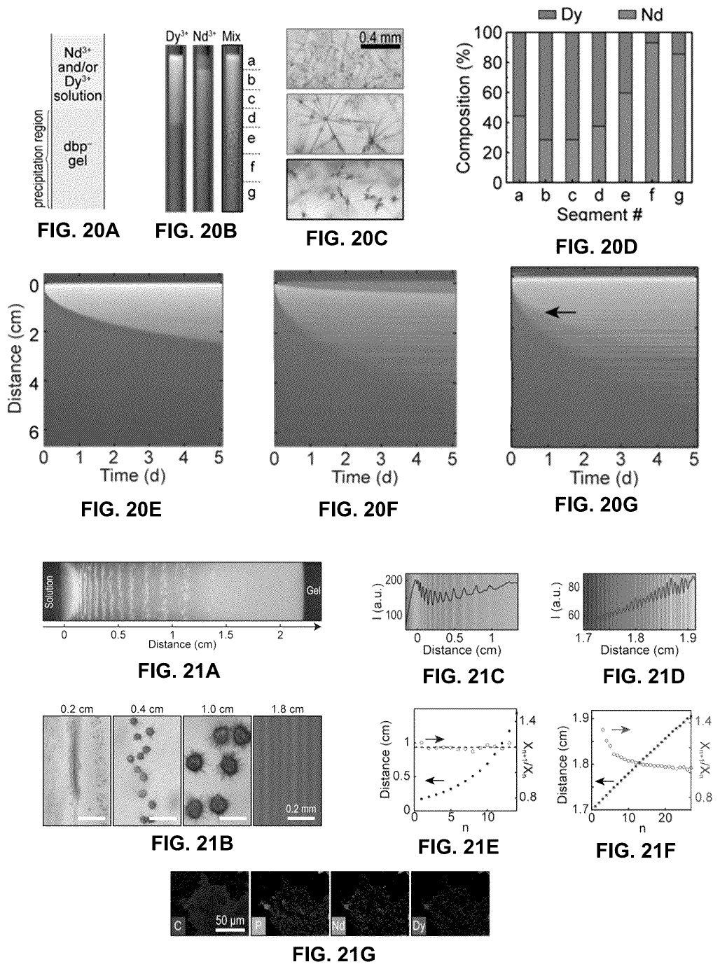

In a first series of experiments in this second set, model solutions with a Nd:Dy molar ratio of 4:1 were investigated. This is a typical ratio for neodymium-based permanent magnets. Specifically, individual and mixed salt solutions of 40 mM neodymium(III) chloride and 10 mM dysprosium(III) chloride were used. These solutions were placed in a tube on top of a layer of agarose gel loaded with 10 mM potassium dibutyl phosphate (Kdbp), a precipitating agent with a promising separation efficiency for these components. Within a few seconds of adding the solution, a white precipitate began to form near the solution-gel interface as ions diffused across the boundary between the two media. Because of the higher reactant concentration in the solution compared to the gel, the precipitate primarily formed in the gel, driven by the concentration gradient. The set up is shown in FIG. 20A while FIG. 20B provides three images of the precipitate containing hydrogel for a Dy only precipitation, a Nd only precipitation, and for a mixed precipitation.

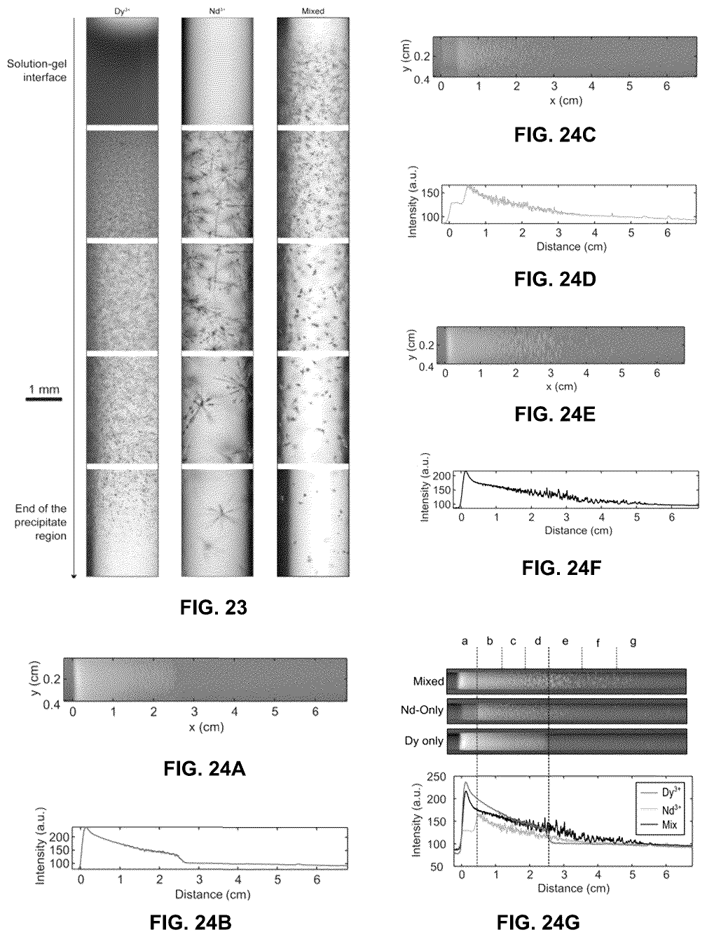

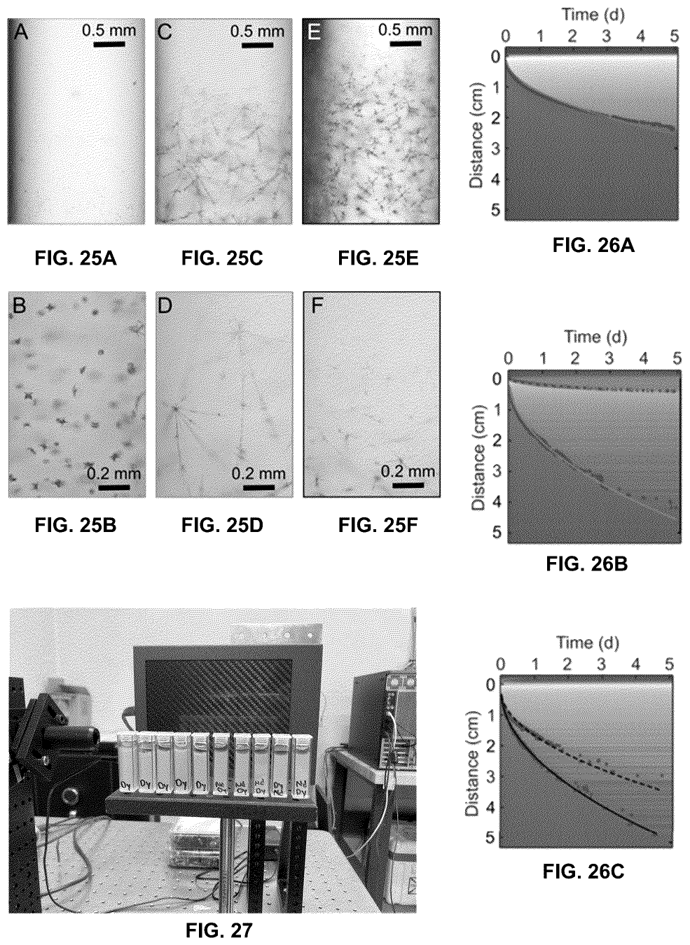

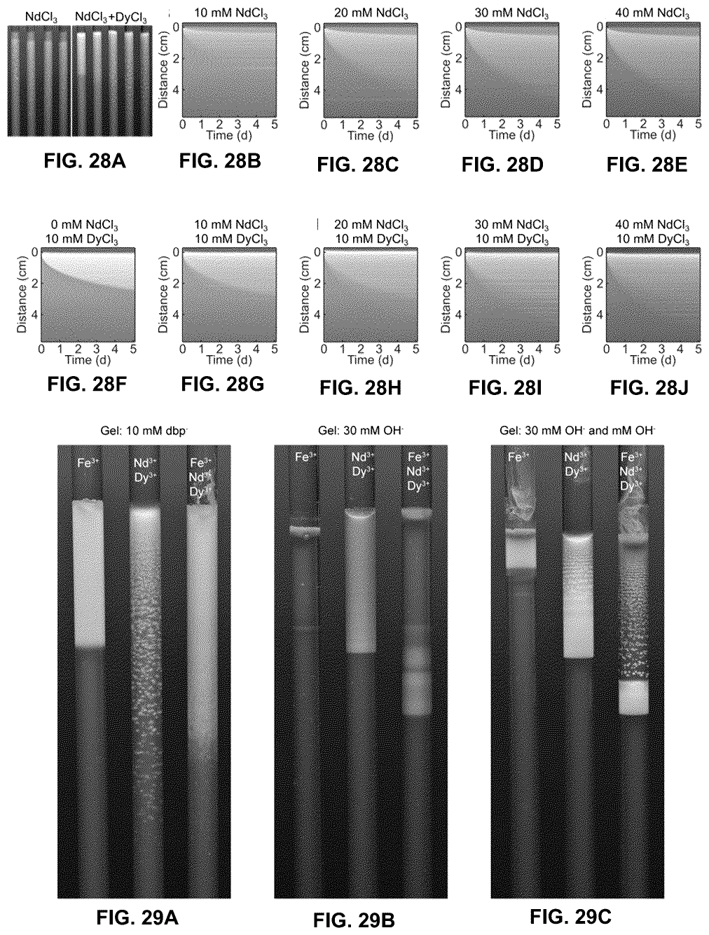

The pattern and dynamics of the precipitate formation varied with the solution composition (FIG. 20B). For example, the DyCl₃—only solution produced a continuous precipitate layer with a decreasing density that extended 26 mm into the gel within 5 days. For the NdCl₃—only solution, the precipitate initially formed near the solution-gel interface, but continuously dissolved and re-precipitated, creating a propagating front that left in its wake a uniform translucent layer. At t=5 days, this layer had a length of 4.2 mm, preceded by a longer precipitate layer of approximately 41 mm. The distribution of solid material in the precipitate was relatively sparse, with decreasing density at further distances from the solution-gel interface. By comparison, the mixed salt solution resulted in a longer precipitate layer, extending 51 mm into the gel. It was observed that only slight dissolution near the interface occurred with the pattern was dominated by the growth of new crystals (FIG. 20B and FIG. 23).

Optical micrographs of the various crystal morphologies in the three solution conditions are presented in FIG. 20C. The Dy-only solution, shown in the top panel of FIG. 20C, produced funnel- and needle-shaped crystals that were individually dispersed and were relatively densely packed. The Nd-only solution, shown in the middle panel of FIG. 20C, produced longer needles that emerged from a seed crystal and were more sparsely distributed. Aggregates of relatively short, pointy needles were observed in the mixed-salt experiment, shown in the bottom panel of FIG. 20C. For all these conditions, the average particle size increased with increasing distance from the solution-gel interface as can be seen in FIG. 23. This observation is consistent with previous studies on precipitation in reaction-diffusion systems and may be ascribed to the change in supersaturation during the process. Initially, the high flux of ions into the gel results in a high nucleation rate that produces a large number of relatively small particles. As the ions are consumed, the nucleation rate decreases significantly. At this stage, precipitation is dominated by the growth of existing particles rather than the nucleation of new particles, resulting in the formation of fewer, larger crystals.

The observed spatial gradients in particle morphology, size, and density suggest the possibility of compositional changes across the precipitate layer. To evaluate this prospect, we quantified the elemental composition of the precipitates using ICP-MS measurements. Gel segments of approximately 7 mm in length were extracted from the mixed-salt experiment of FIG. 20B. The selection of the exact segment locations were informed by qualitative features in the individual salt experiments (FIGS. 24A-24G). A Dy-rich region was observed—with up to 71.6% Dy—in segments (a)-(d) of FIG. 20D. This region extended 26 mm into the gel which was comparable to the total precipitation length of the Dy-only experiment. Beyond this Dy-rich layer, the Nd ratio increased significantly, reaching 93.1% in segment (f) as can be seen in FIG. 20D. These results furnish a low-energy pathway for Dy enrichment and subsequent Nd separation from a mixed feedstock solution via reaction-diffusion coupling.

To examine the dynamics of precipitate formation time-space plots, were constructed by collecting consecutive images of the experiment, averaging individual images across the tube radius, and stacking the resulting 1D profiles as shown in FIGS. 20E-20G. The time-space plot for the Dy-only experiment as shown in FIG. 20E provided a single front corresponding to the propagation of the precipitate in the gel medium. The Nd-only plot as shown in FIG. 20F showed a leading precipitation front and an inner front ascribed to the slow dissolution of the as-formed precipitate. This inner front left residue of partially dissolved crystals observed in optical the micrographs of FIGS. 20E, 20F, 26A and 26B. The particles remained stationary once formed and were visualized in the time-space plots as horizontal lines with slight gaps in between, particularly for the sparser Nd precipitates.

For the mixed-salt experiment shown in FIGS. 20G and 26C, the time-space plot also showed two propagating fronts. However, both fronts were ascribed to precipitation—rather than dissolution—for two key reasons: Firstly, the precipitates were denser within the inner front as indicated by the black arrow of FIG. 20G indicating the formation of additional solid material. Secondly, the inner and outer fronts were approximately overlapping with the precipitation fronts in the Dy-only and Nd-only experiments, respectively shown in FIGS. 26A-26C. By tracking the precipitation fronts, the propagation rates of the precipitation fronts could be evaluated. It was found that the experimental data agreed reasonably well with square root fits (FIGS. 26A-26C), indicating that diffusion plays a key role in the growth process.

Precipitation with Gel Containing Two Reactants

The robustness and versatility of reaction-diffusion separations were tested by increasing the complexity of the feedstock solution. Specifically, we investigated the effect of the presence of iron(III) chloride (FeCl₃) in the feedstock, since dissolved magnets typically contain residual amounts of iron that compromise the separation efficiency and purity. Our approach used two precipitating reagents in the gel to interact primarily with the iron and rare earth elements. We selected KOH as the additional precipitating agent because it forms hydroxide precipitates with non-alkali metal ions and is a widely used commodity chemical in industrial separations.

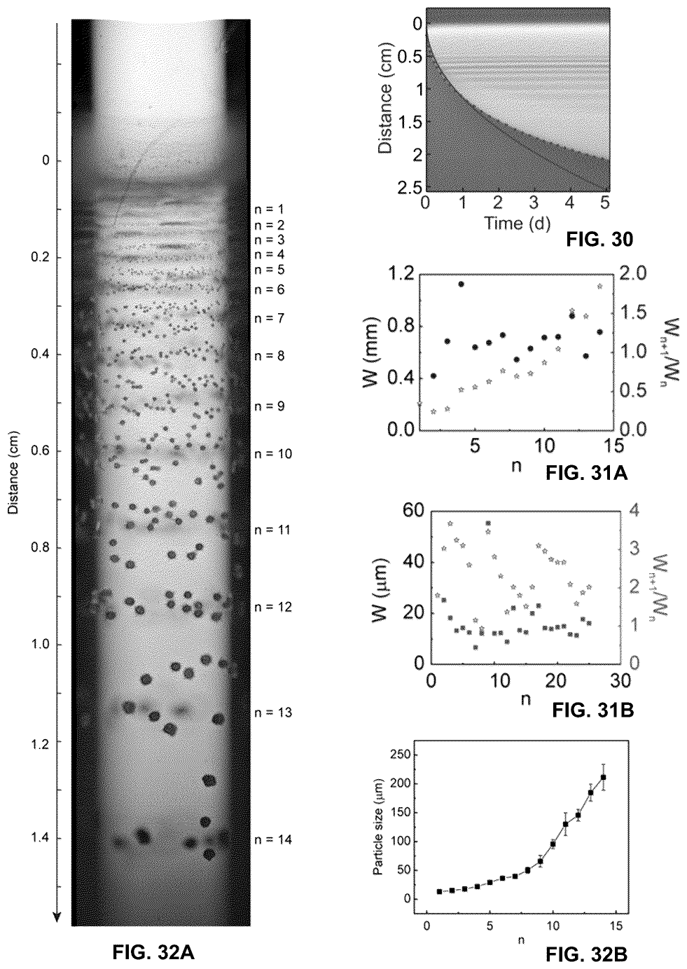

For the control experiments, we performed reaction-diffusion separations on a solution of 40 mM NdCl₃ and 10 mM DyCl₃—not containing iron ions—using a gel loaded with 30 mM KOH as well as 10 mM Kdbp. The resulting precipitate patterns shown in FIG. 21A differed markedly from the Kdbp-only experiments with identical feedstock compositions. Most notably, the formation of periodic precipitation stripes was observed which is a characteristic feature of the Liesegang phenomenon as shown in FIG. 30. The stripe patterns were not observed in experiments with Kdbp-only or KOH-only gel. The stripes consisted of crystals with a spherical core and multiple elongated spikes that grew outward in the radial direction as can be seen in FIG. 21B. While the crystals were localized within well-defined regions, they were not in contact or aggregated together. The crystal size was of low polydispersity within each stripe and increased gradually from the solution-gel interface to the end of the gel, about 17.9±4.7 μm, 83.0±11.1 μm, 147.2±17.8 μm at x=0.1, 0.4, and 1.0 cm, respectively as shown in FIG. 21B. These results were consistent with recent studies on material synthesis using reaction-diffusion coupling, which reported a linear increase in particle size as a function of distance from the solution-gel interface. Further along the tube, a precipitate layer that extended 7.8 mm beyond the final Liesegang stripe was observed. Closer examination showed that this layer also consisted of striped patterns.

To characterize these precipitate patterns, representative images along the tube radius were averaged and a line profile was acquired that displayed the position and width of each stripe, both for the large-scale pattern along the tube length as depicted in FIG. 21C as well as the micro-scale pattern within the final precipitate layer which was located at x>1.4 cm and is shown in FIG. 21D from x=1.7 to x=1.9 cm). The large-scale pattern exhibited classical Liesegang features, with increasing spacing between the stripes such that the ratio of two consecutive stripe positions was nearly constant as shown in the blue dots of FIG. 21E. The empirical spacing coefficient (Xₙ₊₁/Xₙ) was ˜1.2, which is comparable to other Liesegang precipitation patterns. This so-called “spacing law” was complemented by the “time law”; the duration between two consecutive stripes increased, and the system followed a square root dynamics as shown in FIG. 30. However, the stripes had a relatively constant width and hence did not obey the empirical “width law” as shown in FIGS. 31A and 31B. Increasing average particle sizes were also found with increasing band number as shown on the respective image and plot of FIGS. 32A and 32B.

The micro-scale pattern in the final precipitate layer showed qualitatively different features, with a nearly uniform spacing of 76.1±7.4 μm as shown in the black dots of FIG. 21F Similar equidistant stripes were observed when extracting various transition metal hydroxides from battery feedstock solutions.

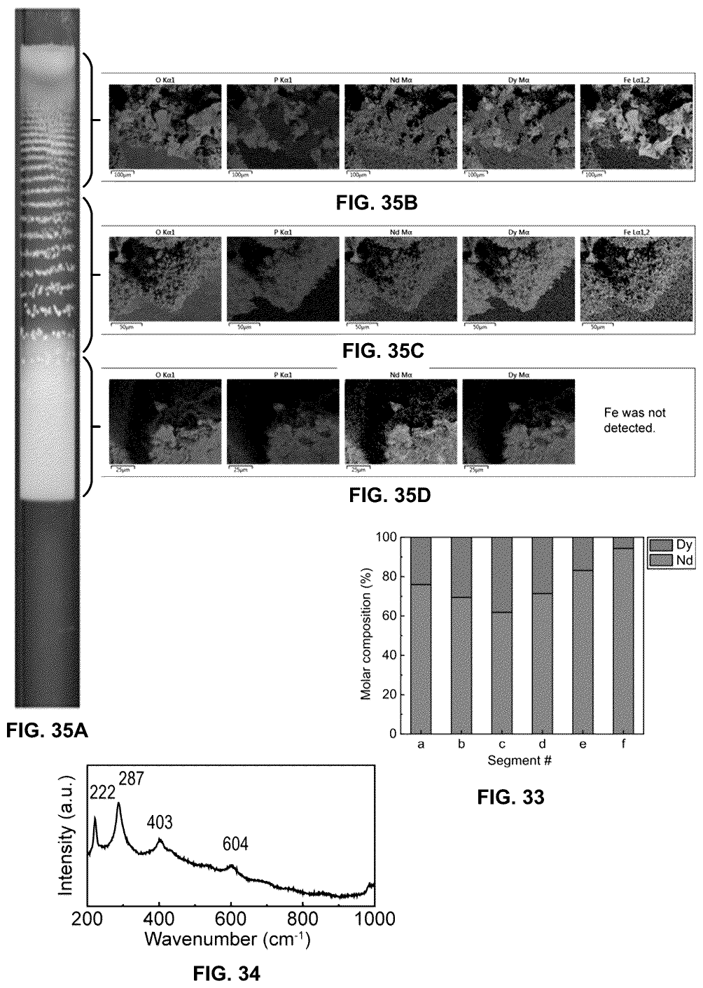

Furthermore, EDS maps of the elemental distribution in the precipitates showed that all the particles contained both Nd and Dy as shown in FIG. 21G. ICP-MS measurements of different segments indicated a slight Dy enrichment in the first half of the gel (up to 38.2%) followed by increasing Nd content as the distance increased, up to a relative purity of 94.3% towards the end of the gel (FIG. 33). These results indicated that the presence of hydroxide (OH⁻) significantly affected the particle morphologies, induced band formation at two different scales, and diminished the enrichment of Dy in the segments closer to the solution-gel interface.

Separation of a Complex Feedstock with a Multi-Reactant-Loaded Gel

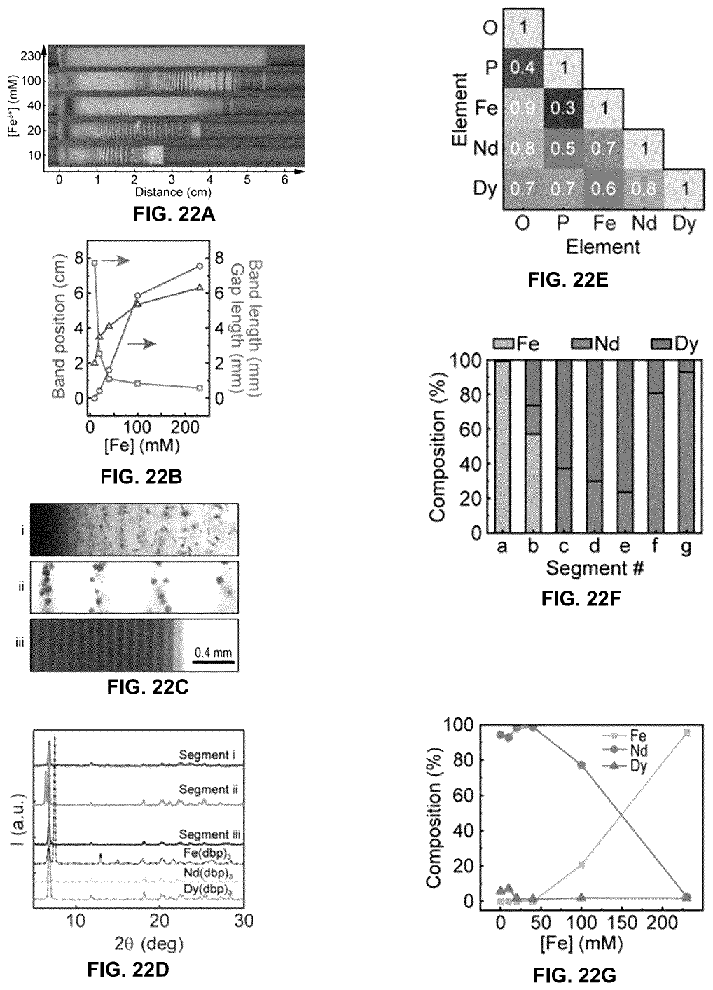

A final set of experiments of the second series involved validating reaction-diffusion separations from model feedstock solutions that included iron, a typical component in recycled NdFeB magnets. We systematically varied the concentration of Fe³⁺ from 10-230 mM with a constant Nd³⁺ concentration of 40 mM and Dy³⁺ concentration of 10 mM as well as a constant gel composition of 10 mM Kdbp and 30 mM KOH. The resulting precipitate patterns are presented in FIG. 22A. The total precipitate length increased from 2.8 cm at [Fe³⁺]=10 mM to 6.2 cm at [Fe³⁺]=230 mM. All of the solution conditions produced a yellowish-orange layer near the solution-gel interface, indicating the presence of iron phases such as FeO(OH), as evident from Raman spectroscopy of FIG. 34. Periodic precipitate stripes were observed in experiments with all Fe concentrations except 230 mM, and the spacing, width, color, and texture of these features varied. In addition, we noticed a leading band propagating at the front of each precipitate pattern, with increasing gap sizes and decreasing band lengths for increasing Fe³⁺ concentrations (FIG. 22B). Moreover, we observed a smooth color gradient of orange to white for [Fe³⁺]230 mM and a striking yellow region at 1.9-2.5 cm for [Fe³⁺]100 mM, indicating the presence of Fe-containing compounds.

As a representative example, we characterized three segments of equal lengths of the precipitate pattern for [Fe³⁺]=10 mM. Optical micrographs showed individual rodlike particles in the first third of the precipitation as shown in FIG. 22C, panel (i) similar to those observed in the Dy-only experiment (FIG. 20C). Further away from the solution-gel interface, the individual rods formed bundles and spherical particles with rough surfaces as shown in FIG. 22C, panel ii. The final segment consisted of equidistant bands as shown in FIG. 22C, panel iii. Furthermore, the XRD patterns of these three segments showed characteristic peaks of Nd(dbp)₃ and/or Dy(dbp)₃. No characteristic peaks of Fe(dbp)₃ or other iron (oxy)hydroxides were found, even in segment (i), where the orange color clearly indicated the presence of Fe. This result suggests that the Fe³⁺ precipitates were primarily in the form of amorphous hydroxides or oxides in this experiment. Accordingly, we collected EDS maps of these precipitates and analyzed the correlation of different elements. Our analysis showed that Fe was highly correlated with O but not with P for segment (i) (FIG. 22E), indicating that Fe³⁺ preferably precipitates with OH⁻ rather than dbp⁻. Nd, Dy, and P were moderately correlated throughout different segments (FIGS. 35A-35D). No detection of Fe signals was found in segment (iii) with EDS.

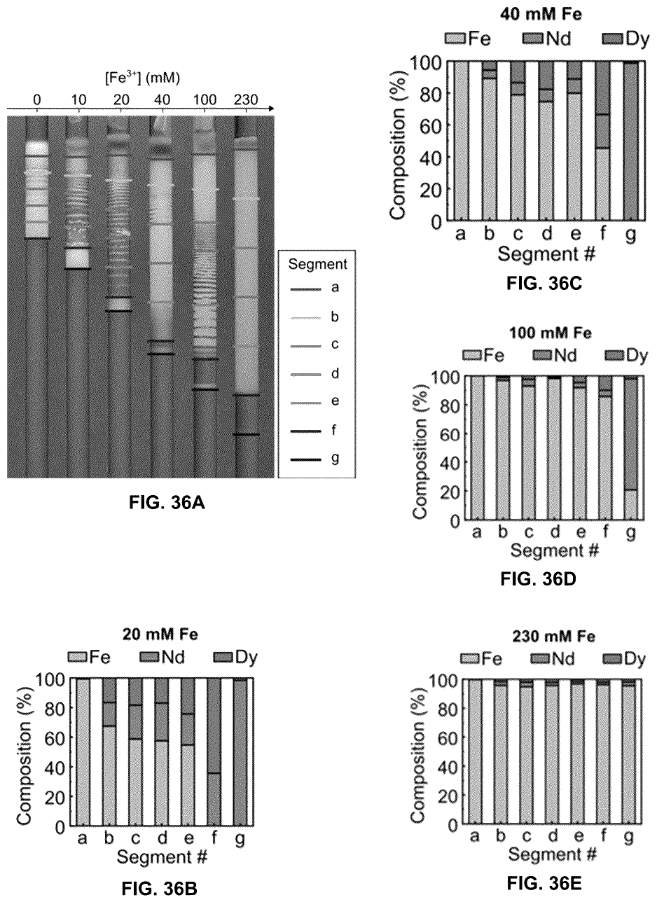

Additional characterization of the elemental composition was performed using ICP-MS by measuring the concentrations of Fe, Nd, and Dy in parts-per-billion (ppb) in the digested samples. The relative percentages of these three components are reported in FIG. 22F. A Fe-pure (99.2%) region was found at the solution-gel interface as shown in FIG. 22F, segment a. The high concentration of Fe drastically decreased to 57.1% in the next segment and was zero for the remaining segments. The Dy ratio increased to 76% in the middle region as seen in FIG. 22F, segments c, d, and e) and then suddenly decreased in segment f, while the Nd content increased reaching 92.9% at the end of the precipitate region as shown in FIG. 22F, segment g. These trends were consistent across a range of solution conditions. Specifically, high Nd purity (up to 98.8%) was consistently found in the last part of the precipitate for a wide range of Fe³⁺ concentrations (0-40 M). Further increases in Fe³⁺ concentration resulted in a high Fe content in the entire precipitates as shown in FIG. 22G and in the variations of FIGS. 36B-36E. These results demonstrate that reaction-diffusion coupling may pre-screen residual iron content in permanent magnet feedstocks, and further enrich and isolate the Dy and Nd components.

### Discussion and Conclusions for the Second Series of Experiments

Based on the experimental and simulated results, key properties of the system that were responsible for successful reaction-diffusion separations were evaluated. For this purpose, the Damköhler ratio, a dimensionless number that compares the relative timescales of the reaction kinetics and transport phenomena occurring in the system, was calculated. For the case of reaction-diffusion coupling, the ratio is given by

$$Da = \frac{{kC}^{n - 1} {λ}^{2}}{2 D}$$

where k, D, C, n, and λ represent the precipitation rate constant, ion diffusion coefficient, reactant concentration, reaction rate order, and length scale, respectively. At the relevant concentration (0.01 M) and length scale (10 cm), the Damköhler ratios are exceedingly small, Da_{Nd}=9.8×10⁻¹⁶ and Da_{Dy}=4.6×10⁻¹³, indicating that the system is reaction-limited. The Damköhler ratios are <<1 for extended length scales of several meters, suggesting that scaling up the reactor dimensions would be favorable for larger throughput separations. This result also demonstrates why reaction-diffusion separation was highly successful for this particular feedstock: in a reaction-limited regime, the vast difference between k_{Nd} and k_{Dy} was the key parameter in controlling the spatial distribution of the corresponding products.

In this second series of experiments reaction-diffusion separations were demonstrated as a viable energy-efficient approach for selectively recovering critical materials from unconventional feedstock solutions, namely permanent magnets that are typically present in spent consumer electronics. Starting with a model mixture of dysprosium(III) and neodymium(III) chloride, we observed the precipitation of a dysprosium-enriched phase followed by a relatively pure neodymium phase along the length of the reaction medium. Moreover, we observed the pre-screening of up to 40 mM of iron by precipitating an oxide phase near the solution-gel interface. This result validated the robustness of reaction-diffusion coupling for handling feedstock complexity.

One potential advantage of reaction-diffusion separations is the chemical versatility and applicability to a variety of feedstock conditions. Other cutting-edge separation methods are based on optimizing atomic-scale properties, such as ligand binding energies, membrane pore sizes, ionic liquid interactions, or equilibrium distributions across various solvents. The challenge with tailoring these properties is that confounding factors in multicomponent solutions and non-ideal conditions may drastically compromise the separation efficiency. In comparison, the reaction-diffusion approach is based on simple precipitation reactions using commodity chemicals that are already deployed in separation industries. Separations are achieved by leveraging subtle differences in the intrinsic physicochemical properties of the target ions, namely the diffusion and precipitation rates, which are more robust to feedstock variability. For example, the first series of experiments reported the extraction of an almost pure manganese phase from model solutions of recycled batteries using sodium hydroxide, with robust results from five candidate cathode materials.

### ADDITIONAL REMARKS

To the extent that any definitions or other teachings set forth in material incorporated herein by reference (i.e. indirectly set forth herein) contradict teachings whose words and figures are set forth herein directly, the order of precedence given to the definitions and other teachings are: (1) teachings set forth directly in the body of the application, then (2) teachings set forth in the incorporated material with incorporated materials having more recent dates taking precedence over incorporated materials having older dates.

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that features and variations of the aspects (as well as features and variations in any embodiments) set forth herein may be grouped in different combinations and sub-combinations to define additional or alternative aspects so long as the combinations are functional.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A reaction-diffusion method for separating at least one target ion that comprises a selected metal atom from a solution containing a plurality of different metal containing ions, comprising:
(a) providing a feedstock solution containing the plurality of different metal containing ions;
(b) providing a hydrogel containing at least one precipitating agent;
(c) placing the feedstock solution in contact with the hydrogel in a reactor to provide a precipitate containing hydrogel by the different metal-containing ions diffusing into the hydrogel with the at least one target ion reacting with the precipitating agent to form at least one target precipitate containing the at least one target ion such that physical separation of the at least one precipitated target ion from the plurality of different metal containing ions occurs, wherein a concentration of the at least one precipitated target ion is increased relative to at least some of the plurality of different metal containing ions within a volume segment of the participate containing hydrogel.

2. The method of claim 1 wherein the concentration of the at least one precipitated target ion within the volume segment has a concentration compared to any other precipitated metal containing ions in the volume segment selected from the group consisting of: (1) at least 50%, (2) at least 70%, (3) at least 90%, and (4) at least 95%.

3. The method of claim 1 wherein the contact surface of the hydrogel and the feedstock comprises one or more surfaces selected from the group consisting of: (i) an upper surface, (ii) a lower surface, (iii) a side-facing surface.

4. The method of claim 1 wherein the reactor comprises multiple separated volumes of hydrogel with each volume providing at least one contact surface.

5. The method of claim 1 wherein the at least one target ion comprises at least two target ions with each including a different metal wherein the separation provides an increased concentration of a first of the two target ions at one volume segment and an increased concentration of a second of the two target ions at a second volume segment that is different from the first volume segment.

6. The method of claim 5 where the at least two target ions comprise metals selected from at least one group consisting of: (1) rare earth metals, (2) transition metals, (3) alkali metals, and (4) lanthanide metals.

7. The method of claim 1 wherein the hydrogel comprises a material selected from the group consisting of: (1) agarose, (2) gelatin, (3) chitosan.

8. The method of claim 7 wherein the at least one precipitating agent comprises a material selected from the group consisting of (1) hydroxides, (2) phosphates, and (3) oxalates.

9. The method of claim 8 wherein the at least one precipitating agent comprises at least two precipitating agents.

10. The method of claim 1 wherein the at least one target precipitate containing the at least one target ion comprises at least one metal target atom in a form selected from (1) an ion containing the at least one target metal, and (2) an atom of the metal in non-ionic form.

11. A method for recovering an enhanced concentration of at least one target metal or metal salt from a solution containing a plurality of ions containing different metals including at least one target ion containing the at least one target metal, comprising:
(a) separating the at least one target ion from a solution containing the plurality of ions, comprising:
1) providing a feedstock solution containing the plurality of different ions;
2) providing a hydrogel containing at least one precipitating agent;
3) placing the feedstock solution in contact with the hydrogel in a reactor to form a precipitate containing hydrogel having different ions diffused into the hydrogel with the at least one target ion reacting with the precipitating agent to precipitate at least one target ion such that physical separation of the at least one target ion from at least one other ion occurs wherein a concentration of the at least one target ion is increased at at least one location in the participate containing hydrogel wherein the target ion is incorporated into the at least one target metal or metal salt;
(b) physically dividing the precipitate containing hydrogel into at least two volume segments having different concentrations of one or more participated metal containing ions;
(c) processing at least one of the at least two volume segments to obtain the at least one target metal or metal salt with an enhanced concentration relative to at least one other precipitated metal or metal salt.

12. The method of claim 11 wherein the at least one target metal or metal salt with the enhanced concentration has a concentration, compared to any other precipitated metal or metal containing salt in the volume segment, selected from the group consisting of: (1) at least 50%, (2) at least 70%, (3) at least 90%, and (4) at least 95%.

13. The method of claim 11 wherein the contact of the hydrogel and the feedstock occurs at one or more surfaces selected from the group consisting of: (i) an upper surface, (ii) a lower surface, and (iii) a side-facing surface.

14. The method of claim 11 wherein the reactor comprises multiple separated volumes of hydrogel with each volume providing at least one contact surface.

15. The method of claim 11 wherein the at least one target ion comprises at least two target ions with each including a different metal wherein the separation provides an increased concentration of a first of the two target ions at one volume segment and an increased concentration of a second of the two target ions at a second volume segment that is different from the first volume segment.

16. The method of claim 15 where the at least two target ions comprise metals selected from at least one group consisting of: (1) rare earth metals, (2) transition metals, (3) an alkali metals, and (4) lanthanide metals.

17. The method of claim 11 wherein the hydrogel comprises a material selected from the group consisting of: (1) agarose, (2) gelatin, (3) chitosan.

18. The method of claim 17 wherein the at least one precipitating agent comprises a material selected from the group consisting of (1) hydroxides, (2) phosphates, and (3) oxalates.

19. The method of claim 18 wherein the at least one precipitating agent comprises at least two precipitating agents.

20. The method of claim 12 wherein the at least one target metal or metal salt comprises a metal salt with an enhanced concentration that is further processed to provide a quantity of at least one target metal.
